(19) United States
(12) Patent Application Publication
(10) Pub. No.: US 2010/0296074 A1
(43) Pub. Date: Nov. 25, 2010

(54) EXPOSURE METHOD, AND DEVICE MANUFACTURING METHOD

(75) Inventors: Yasuhiro MORITA, Kumagaya-shi (JP); Shigeru HIRUKAWA, Tokyo (JP); Koichi FUJII, Fukaya-shi (JP)

Correspondence Address: OLIFF & BERRIDGE, PLC, P.O. BOX 320850, ALEXANDRIA, VA, 22320-4850, US

(73) Assignee: Nikon Corporation, Tokyo (JP)

(21) Appl. No.: 12/769,088

(22) Filed: Apr. 28, 2010

Related U.S. Application Data
(60) Provisional application No. 61/213,606, filed on Jun. 24, 2009.
(60) Provisional application No. 61/213,607, filed on Jun. 24, 2009.
(60) Provisional application No. 61/213,609, filed on Jun. 24, 2009.

(30) Foreign Application Priority Data
Apr. 30, 2009 (JP) 2009-110627
Apr. 30, 2009 (JP) 2009-110641
Apr. 30, 2009 (JP) 2009-110654
Apr. 27, 2010 (JP) 2010-102399
Apr. 27, 2010 (JP) 2010-102434
Apr. 27, 2010 (JP) 2010-102458

(51) Int. Cl. G03B 27/32

(52) U.S. Cl. 355/77

(57) ABSTRACT

A lateral shift ΔX_{AM} of an image of an alignment mark projected on a wafer is obtained for a plurality of linewidth (a to d) which are different to one another and defocus amount (ΔZ), taking into consideration an illumination condition and optical properties of a projection optical system, and the linewidth of the alignment mark is optimized, so that an average (a lateral shift when ΔZ=0) and variation (variation of the lateral shift within a range of the degree of focus error) of lateral shift ΔX_{AM} is minimized. This allows the alignment mark to be designed with a small deformation, even if the mark is transferred in a defocused state.

### CROSS-REFERENCE TO RELATED APPLICATIONS

This non-provisional application claims the benefit of Provisional Application No. 61/213,606 filed Jun. 24, 2009, Provisional Application No. 61/213,607 filed Jun. 24, 2009, and Provisional Application No. 61/213, 609 filed Jun. 24, 2009, the disclosures of which are hereby incorporated herein by reference in its entirety.

### BACKGROUND OF THE INVENTION

1. Field of the Invention

The present invention relates to exposure methods, device manufacturing methods, and overlay error measurement methods, and more particularly, to an exposure method in which a pattern is formed on an object via a projection optical system, a device manufacturing method in which an electronic device is manufactured using the exposure method, and an overlay error measurement method in which an overlay measurement error is measured of patterns of different layers that are formed overlaid in a plurality of divided areas arranged on an object.

2. Description of the Background Art

Conventionally, in a lithography process for manufacturing electron devices (microdevices) such as semiconductor devices (such as integrated circuits) and liquid crystal display devices, exposure apparatuses such as a projection exposure apparatus by a step-and-repeat method (a so-called stepper) and a projection exposure apparatus by a step-and-scan method (a so-called scanning stepper (which is also called a scanner) are mainly used.

In this type of exposure apparatus, by irradiating an illumination light on a mask (or reticle) on which a pattern is formed and projecting an image of the pattern on a substrate (such as a wafer or a glass plate) to which a photosensitive agent (resist) is applied via a projection optical system, the pattern is transferred onto each of a plurality of shot areas on the substrate. And, the electronic device referred to above is manufactured by forming a plurality of layers of patterns which are overlaid on a substrate. This requires a high overlay accuracy of accurately overlaying and transferring the image of the pattern on a pattern which is already formed in each shot area on the substrate.

Now, by overlaying and forming a pattern on a substrate, an unevenness may occur on a surface of the substrate. Especially, a street (also referred to as a scribe line or a scribe lane) where an alignment mark and the like are formed could be recessed with respect to a shot area on which a device pattern is formed. In this case, when the device pattern is transferred in focus with the shot area, the alignment mark may be transferred onto the street in a defocused state, which may form a deformed and/or a shifted alignment mark.

Because numerical aperture is becoming larger in a projection optical system due to finer patterns in recent years while the depth of focus is becoming smaller, as a consequence, a deformation large enough to cause a misdetection of an alignment mark could be brought about even if the degree of defocus is small. Accordingly, when overlay of a pattern is performed using an alignment mark which has been formed in a deformed and/or a shifted manner, an overlay error of a degree which could not be ignored may occur.

### SUMMARY OF THE INVENTION

According to a first aspect of the present invention, there is provided an exposure method in which a pattern is overlaid and formed in each of a plurality of first areas arranged on an object via a projection optical system, the method comprising: performing a suppressing means of an exposure error occurring due to a positional shift of a second area in which a mark corresponding to the plurality of first areas and the first area corresponding to the mark within a plane orthogonal to an optical axis of the projection optical system when the pattern is formed in each of the plurality of first areas arranged on the object.

According to this method, when a pattern is formed in each of the plurality of first areas, because an exposure error due to a positional shift within the plane orthogonal to the optical axis of the projection optical system is suppressed, it becomes possible to perform an exposure with good overlay accuracy.

In this case, the exposure error may include not only a positional error, but also a rotation, magnification and/or a shape error. The point is, any error can be included, as long as suppressing such error leads to an improvement in the overlay accuracy within the plane orthogonal to the optical axis of the projection optical system. Further, suppressing also includes the case of blocking the generation of such exposure errors described above.

According to a second aspect of the present invention, there is provided a second exposure method in which a pattern is overlaid and formed in each of a plurality of first areas arranged on an object, the method comprising: performing exposure to the object to reduce a step of a target portion, which is at least a part of a second area on which a plurality of first marks are formed corresponding to the plurality of first areas, with respect to the first area, by detecting the plurality of first marks and performing alignment of the object to a predetermined point based on results of the detection; and forming a second mark on the target portion and overlaying and forming the pattern in each of the plurality of first areas, by detecting the plurality of first marks, performing alignment of the object to a predetermined point based on results of the detection, and exposing the object.

According to this method, it becomes possible to maintain sufficient overlay accuracy.

According to a third aspect of the present invention, there is provided a device manufacturing method, including forming a pattern on an object by one of the first and second exposure methods of the present invention; and developing the object on which the pattern is formed.

According to this method, it becomes possible to produce highly integrated devices with good productivity (including yield).

According to a fourth aspect of the present invention, there is provided a device manufacturing method including overlaying and forming a pattern in each of a plurality of first areas arranged on an object, the method comprising: performing a flattening processing to flatten a target portion, which is at least a part of a second area on which a plurality of first marks are formed corresponding to the plurality of first areas, by detecting the plurality of first marks and performing alignment of the object to a predetermined point based on results of the detection; and detecting the plurality of first marks, performing alignment of the object to a predetermined point based on results of the detection, and forming a second mark on the target portion which has been flattened with respect to the first area.

According to this method, by overlaying and forming the pattern in each of the plurality of first areas arranged on the object using the second mark, it becomes possible to maintain sufficient overlay accuracy, and as a consequence, becomes possible to manufacture highly integrated device with good productivity.

According to a fifth aspect of the present invention, there is provided an overlay error measurement method in which an overlay error for two patterns formed via a projection optical system on each of a reference layer and a target layer on an object is measured, the method comprising: optimizing a design condition of a mark by obtaining a first positional shift of an image of the pattern projected on the object via the projection optical system and an image of the mark within the plane orthogonal to the optical axis of the projection optical system, with respect to a second positional shift of the image of the pattern and the image of the mark in a direction parallel to the optical axis, and optimizing a design condition of the mark, based on the second positional shift and the corresponding first positional shift, for each of a plurality of conditions including an illumination condition to illuminate a mask on which the pattern and the mark are formed taking into consideration optical properties of the projection optical system; performing an exposure using a first mask on which a first pattern and a first mark whose positional relation is known is formed, so as to form the first pattern in a plurality of first areas on a reference layer of the object via the projection optical system, and at the same time, form the first mark in a second area corresponding to the plurality of first areas; performing an exposure using a second mask on which a first pattern and a second mark whose design condition is optimized by the optimizing and positional relation is known is formed, so as to form the second pattern on a target layer overlaying the first pattern on the object, and at the same time, form the second mark overlaying the first mark in the second area; and computing an overlay error of the first pattern and the second pattern, by measuring a positional shift of the first mark formed on the second area on the object and the second mark.

According to this method, an overlay error of the first pattern and the second pattern formed via a projection optical system on a reference layer and a target layer on the object, respectively, can be measured with good precision.

According to a sixth aspect of the present invention, there is provided an overlay error measurement method in which an overlay error for two patterns formed via a projection optical system on each of a reference layer and a target layer on an object is measured, the method comprising: obtaining a first positional shift within a plane orthogonal to the optical axis of the projection optical system for an image of the pattern projected on a first area on the object via the projection optical system and an image of the mark projected on a second area on the object via the projection optical system, at least taking into consideration optical properties of the projection optical system; performing an exposure using a mask on which a first pattern and a first measurement mark whose positional relation is known is formed, so as to form the first pattern in the first area on a reference layer of the object via the projection optical system, and at the same time, form the first measurement mark in the second area; performing an exposure using a mask on which a second pattern and a second measurement mark is formed, so as to form the second pattern on a target layer overlaying the first pattern on the object, and at the same time, form the second mark overlaying the first mark in the second area; and computing an overlay error of the first pattern and the second pattern, by measuring a positional shift of the first measurement mark formed on the second area on the object and the second measurement mark.

According to this method, an overlay error of the first pattern and the second pattern formed via a projection optical system on a reference layer and a target layer on the object, respectively, can be measured with good precision.

### BRIEF DESCRIPTION OF THE DRAWINGS

In the accompanying drawings;

FIG. 1 is a view showing a rough configuration of an exposure apparatus which is used to execute an exposure method of a first embodiment;

FIG. 2 is a block diagram used to explain an input/output relation of a main controller equipped in the exposure apparatus in FIG. 1;

FIG. 3A is a planar view that shows a surface of a reticle, and FIG. 3B is an enlarged view of an alignment mark formed on the reticle;

FIG. 4A is a view used to explain a shot area on a wafer, FIG. 4B is an enlarged view of a periphery of a shot area, and FIG. 4C is a sectional view of arrow B-B in FIG. 4B;

FIGS. 5A and 5B are views used to describe a resist pattern which is formed when defocus amount ΔZ=0, respectively;

FIGS. 6A and 6B are views used to describe a resist pattern which is formed when defocus amount ΔZ=−1, respectively;

FIGS. 7A and 7B are views used to describe a resist pattern which is formed when defocus amount ΔZ=+1, respectively;

FIG. 8 is a view used to explain a relation between lateral shift ΔX_{AM} and defocus amount ΔZ;

FIG. 9 is a view used to explain an intensity distribution in the X-axis direction of an aerial image of L/S pattern LSX;

FIG. 10 is a view used to explain a relation between linewidth, lateral shift ΔX_{AM}, and defocus amount ΔZ;

FIG. 11 is a view used to explain a relation between linewidth L and the average and tilt of lateral shift ΔX_{AM};

FIG. 12 is a view used to explain an intensity distribution of a detection signal of L/S pattern LSX detected using an alignment detection system;

FIG. 13A is a view showing a lateral shift obtained for each image height within an exposure area, and FIGS. 13B to 13D are views showing an offset, X scaling, and orthogonal degree with respect to the exposure area obtained from each lateral shift;

FIG. 14 is a view used to explain a reticle used in a dummy-pattern exposure;

FIGS. 15A to 15C each are views (No. 1) used to explain a procedure of forming a dummy pattern, and forming a new alignment mark on the dummy pattern which has been formed;

FIGS. 16A to 16D each are views (No. 2) used to explain a procedure of forming a dummy pattern, and forming a new alignment mark on the dummy pattern which has been formed;

FIG. 17 is a view used to explain a modified example of a reticle used in the dummy-pattern exposure; and

FIGS. 18A to 18C are views to explain a modified example related to an overlay error measurement.

### DESCRIPTION OF THE EMBODIMENTS

### A First Embodiment

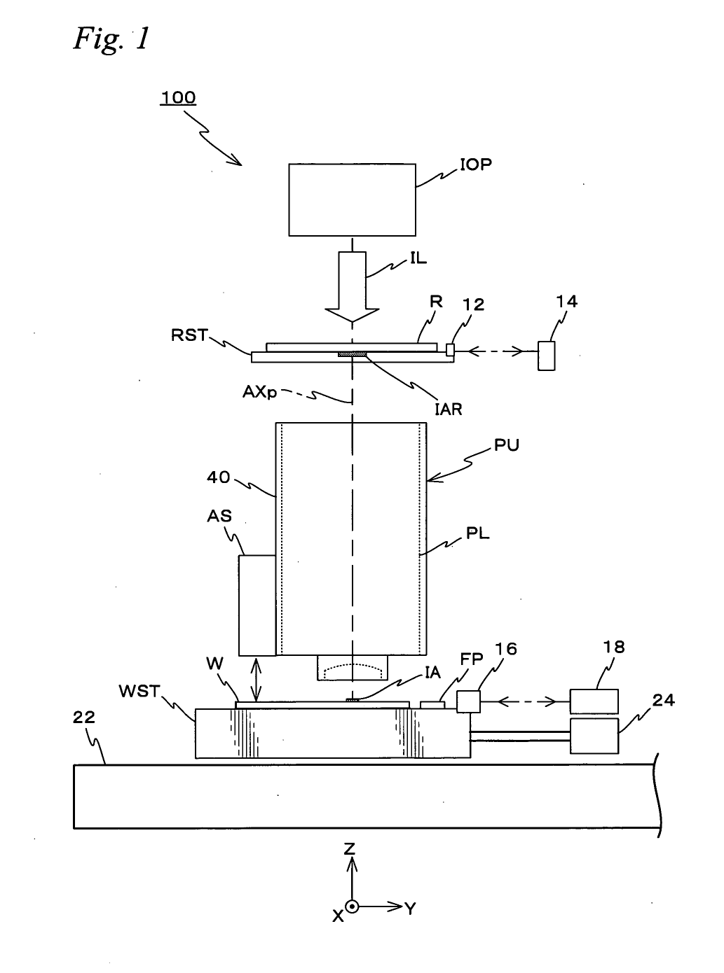

A first embodiment of the present invention will be described below, with reference to FIGS. 1 to 12. FIG. 1 shows a schematic configuration of an exposure apparatus 100 which is used to execute an exposure method of the first embodiment. Exposure apparatus 100 is a projection exposure apparatus by the step-and-scan method, or a so-called scanner.

Exposure apparatus 100, as shown in FIG. 1, is equipped with an illumination system IOP, a reticle stage RST that holds a reticle R, a projection unit PU including a projection optical system PL, a wafer stage WST that holds a wafer W, and a control system and the like of these members.

In the description below, a direction parallel to an optical axis AXp of projection optical system PL will be described as the Z-axis direction, a direction within a plane orthogonal to the Z-axis direction in which reticle R and wafer W are relatively scanned will be described as the Y-axis direction, a direction orthogonal to the Z-axis and the Y-axis will be described as the X-axis direction, and rotational directions around the X-axis, the Y-axis, and the Z-axis will be described as θx, θy, and θz directions, respectively.

Illumination system IOP includes a light source and illumination optical system which is connected to the light source via a light-transmitting optical system, and illuminates a slit-shaped illumination area IAR extending in the X-axis direction which is set by a reticle blind (a masking system), with an illumination light (exposure light) IL in a substantially uniform illuminance. In this case, as illumination light IL, an ArF excimer laser beam (wavelength 193 nm) is used. Incidentally, a configuration of illumination system IOP is disclosed in, for example, U.S. Patent Application Publication No. 2003/0025890 and the like.

Reticle stage RST is placed on the −Z side of illumination system IOP. On reticle stage RST, reticle R is fixed, for example, by vacuum chucking.

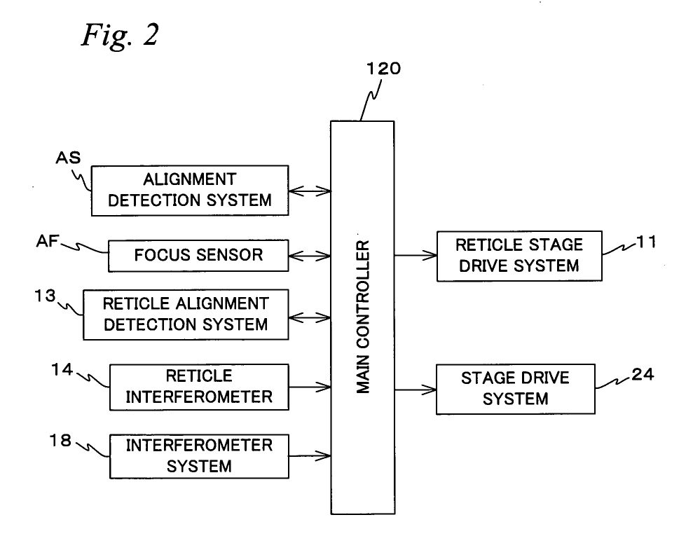

Reticle stage RST is finely drivable within an XY plane by a reticle stage drive system 11 (not shown in FIG. 1, refer to FIG. 2) that includes, for example, a linear motor or the like, and is also drivable in the Y-axis direction in a predetermined stroke range.

Positional information (including rotation information in the θz direction) of reticle stage RST in the XY plane is constantly detected, for example, at a resolution of around 0.25 nm by a reticle laser interferometer (hereinafter referred to as a “reticle interferometer”) 14, via a movable mirror 12 (or a reflection surface formed on an edge surface of reticle stage RST). Measurement information of reticle interferometer 14 is supplied to a main controller 120 (drawing omitted in FIG. 1, refer to FIG. 2).

Above reticle stage RST, although it is omitted in FIG. 1, a pair of reticle alignment detection systems 13 (refer to FIG. 2) is provided consisting of a TTR (Through The Reticle) alignment system which uses light of an-exposure wavelength, as is disclosed in, for example, U.S. Pat. No. 5,646,413 and the like. Detection signals of each of the reticle alignment detection systems 13 are supplied to main controller 120.

Projection unit PU is placed on the −Z side of reticle stage RST. Projection optical system PL is held inside a barrel 40.

As projection optical system PL, for example, a dioptric system is used, consisting of a plurality of lenses (lens elements) that is disposed along optical axis AXp. Projection optical system PL is, for example, a both-side telecentric dioptric system and has a predetermined projection magnification β (β is, for example, ¼, ⅕ or ⅛ times, or the like).

On a side surface of barrel 40 of projection unit PU, an alignment detection system AS is provided which detects an alignment mark and a fiducial mark formed on wafer W. In this case, as alignment detection system AS, an FIA (Field Image Alignment) system is used, which is a type of image-forming alignment sensor by an image processing method that illuminates a broadband (wideband) light such as of a halogen lamp on a mark, and measures the mark position by performing image processing of the mark image. Further, alignment detection system AS has a focus detection system incorporated, which detects a position (defocus amount) in an optical axis direction (the Z-axis direction) of an alignment optical system in the area on which the mark is formed on mark detection. An image-forming alignment sensor having such a focus detection system incorporated is disclosed in, for example, U.S. Pat. No. 5,721,605 and the like. Detection information and measurement information of this alignment detection system AS are supplied to main controller 120.

Wafer stage WST is driven on a stage base 22 placed on the −Z side of projection unit PU, by a stage drive system 24 including a linear motor and the like, in the X-axis direction and the Y-axis direction with predetermined strokes, and is also finely driven in the Z-axis direction, the θx direction, the θy direction, and the θz direction.

On wafer stage WST, wafer W is held by vacuum suction or the like by a wafer holder (not shown). Incidentally, instead of wafer stage WST, a stage device, which is equipped with a first stage moving in the X-axis direction, the Y-axis direction, and the θz direction, and a second stage finely moving in the Z-axis direction, the ex direction, and the θy direction, can also be used.

On wafer stage WST, a fiducial plate FP is fixed in a state where its surface is at the same height as the surface of wafer W. On the surface of fiducial plate FP, a reference mark used in baseline measurement and the like of alignment detection system AS, and at least a pair of reference marks and the like detected by reticle alignment detection system 13 are formed.

Furthermore, in wafer stage WST, an aerial image measuring instrument which measures an aerial image of a pattern projected on wafer W via projection optical system PL, an illuminance monitor (or an uneven illuminance measuring sensor) which measures the intensity (illuminance) of the illumination light irradiated on wafer W, a wavefront aberration measuring instrument (none of which are shown) and the like are equipped. As the aerial image measuring instrument, a measuring instrument having a configuration disclosed in, for example, U.S. Patent Application Publication No. 2002/0041377 and the like can be employed. As the uneven illuminance measuring sensor, a sensor having a configuration that is disclosed in, for example, U.S. Pat. No. 4,465,368 and the like can be employed. As the wavefront aberration measuring instrument, a measuring instrument by the Shack-Hartman method that is disclosed in, for example, PCT International Publication No. 03/065428 and the like, can be employed. Incidentally, detection of marks of reticle R and of fiducial marks wafer stage WST can be performed using an aerial image measuring instrument, instead of reticle alignment detection system 13. In this case, reticle alignment detection system 13 does not have to be provided.

Positional information (rotation information (yawing amount (rotation amount θz in the θz direction), pitching amount (rotation amount θx in the θx direction), and rolling amount (rotation amount θy in the θy direction) of wafer stage WST in the XY plane is constantly detected, for example, at a resolution of around 0.25 nm by a laser interferometer system (hereinafter shortened and referred to as an “interferometer system”) 18, via a movable mirror 16 (or a reflection surface formed on an edge surface of wafer stage WST).

Measurement information of interferometer system 18 is supplied to main controller 120. Main controller 120 controls the position (including rotation in the θz direction) within the XY plane of wafer stage WST via stage drive system 24, based on the measurement information of interferometer system 18.

Further, the position of the surface in the Z-axis direction and the amount of inclination of wafer W are measured by a focus sensor AF (refer to FIG. 2) consisting of a multiple point focal position detection system of an oblique incidence method as the one disclosed in, for example, U.S. Pat. No. 5,448,332 and the like. Measurement information of focus sensor AF is supplied to main controller 120.

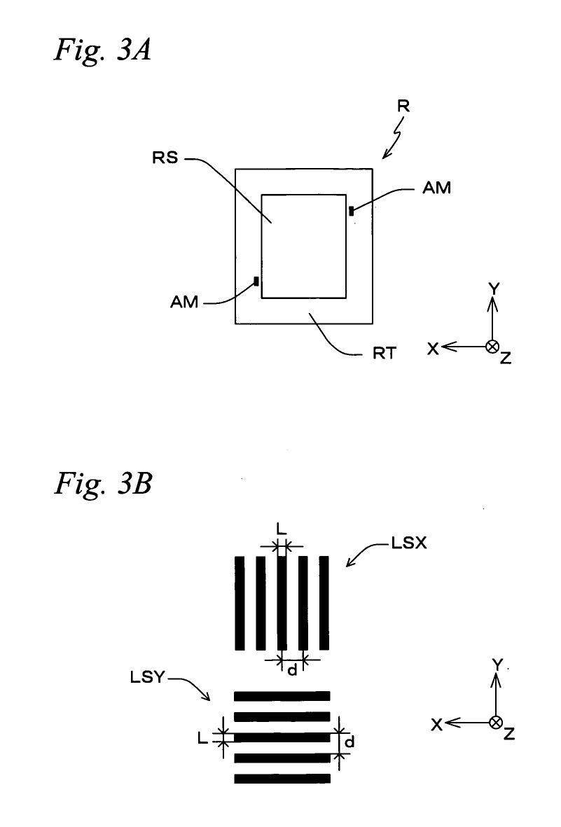

Now, reticle R consists of a rectangular glass substrate. And, on the glass substrate, as an example, a pattern area RS having a device pattern (simply referred to as a pattern) is formed, as is shown in FIG. 3A which is a planar view of reticle R when viewing the reticle from a pattern surface side (the −Z side in FIG. 1). Further, on the glass substrate, an alignment mark AM which is similar is formed each on the −X side and the +X side of pattern area RS.

As shown in an example in FIG. 3B, alignment mark AM has two line-and-space patterns (L/S patterns) LSX and LSY lined in the Y-axis direction. L/S pattern LSX is a group of five line patterns having a linewidth L (for example, 2 μm) arranged at an equal distance d (for example, 6 μm) in the X-axis direction. L/S pattern LSY is a group of five line patterns having a linewidth L arranged at equal distance d in the Y-axis direction.

Incidentally, in reticle R, pattern area RS consists of a light shielding section which shields light, and a pattern is formed which consists of a light transmitting section transmitting light inside the light shielding section. More specifically, reticle R is a negative type reticle (a negative type photomask). In reticle R, an area RT excluding pattern area RS is a light transmitting section. In area RT, an alignment mark AM which includes a line pattern consisting of a light shielding section is formed.

In exposure apparatus 100 of the embodiment, when illumination area IAR on reticle R is illuminated with illumination light IL from illumination system IOP, by illumination light IL which has passed through reticle R placed so that its pattern surface substantially coincides with a first surface (object surface) of projection optical system PL, a reduced image of a circuit pattern (a reduced image of a part of the circuit pattern) of reticle R within illumination area IAR is formed on an area (hereinafter also referred to as an exposure area) IA conjugate with illumination area IAR on wafer W placed on a second surface (image plane surface) side of projection optical system PL and whose surface is coated with a resist (a photosensitive agent), via projection optical system PL (projection unit PU). And by reticle stage RST and wafer stage WST being synchronously driven, reticle R is relatively moved in the scanning direction (the Y-axis direction) with respect to illumination area IAR (illumination light IL) while wafer W is relatively moved in the scanning direction (the Y-axis direction) with respect to exposure area IA (illumination light IL), thus scanning exposure of a shot area (divided area) on wafer W is performed, and the pattern of reticle R is transferred onto the shot area. That is, in the embodiment, the pattern of reticle R is generated on wafer W by illumination system IOP and projection optical system PL, and by exposing the photosensitive layer (resist layer) on wafer W with illumination light IL, the pattern is formed on wafer W.

An exposure method in exposure apparatus 100 will now be briefly described.

In response to instructions of main controller 120, reticle R is mounted on reticle stage RST by a reticle loader (not shown).

Wafer W whose surface is coated with a photosensitive agent (resist) in a coater developer (C/D) (not shown) provided along with exposure apparatus 100, such as connected in-line, and on which a resist layer is formed, is mounted on the wafer holder (not shown) of wafer stage WST.

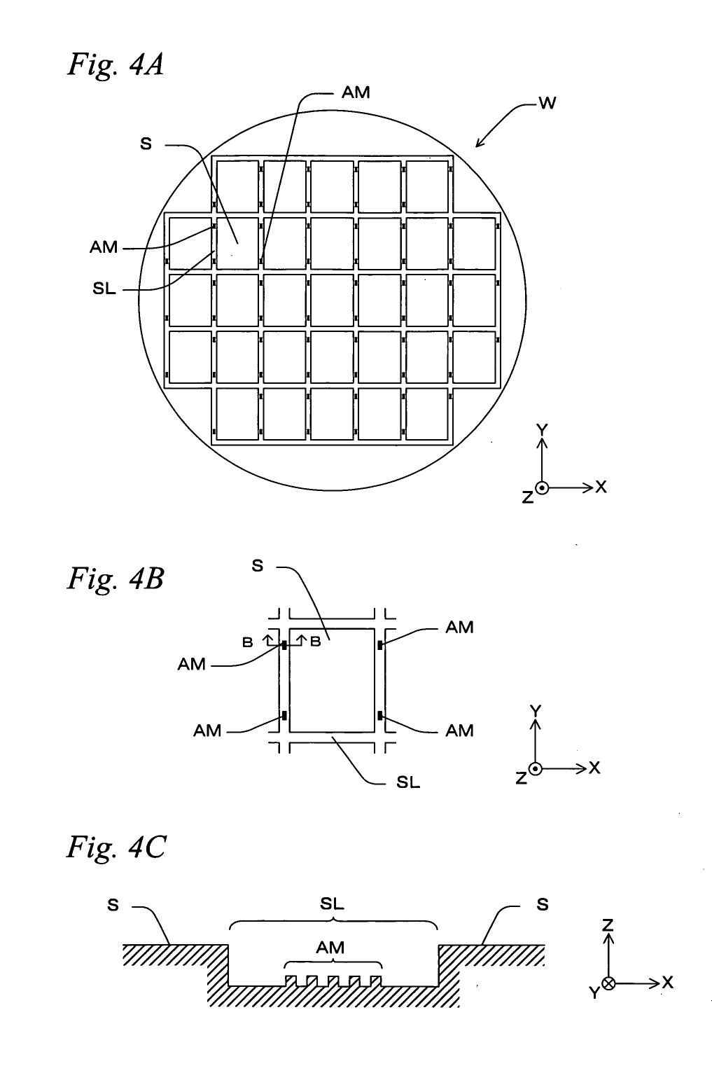

On wafer W, a plurality of shot areas S is arranged, as shown in FIG. 4A as an example. And, in each shot area, a pattern is formed by exposure and device processing treatment to the previous layer. Further, in a gap SL between adjacent shot areas, a plurality of alignment marks AM is formed. This gap SL is also called a street line or a scribe line, and will hereinafter simply be referred to as a street.

In street SL surrounding one shot area S, four alignment marks AM are formed as shown in FIG. 4B as an example. In this case, alignment mark AM positioned on the +Y side of the two alignment marks AM on the −X side of shot area S and alignment mark AM positioned on the −Y side of two alignment marks AM on the +X side of shot area S are the alignment marks arranged in shot area S. Positional relation between the two alignment marks AM arranged in shot area S and shot area S corresponds to the positional relation between alignment marks AM and pattern area RS on reticle R. Incidentally, the remaining alignment marks AM are alignment marks which are arranged in adjacent shot areas.

Of the plurality of alignment marks formed in street SL on wafer W, main controller 120 performs an alignment measurement in which a plurality of alignment marks AM that have been decided beforehand are detected using alignment detection system AS. As a result, an X position and a Y position (to be precise, an X position of L/S pattern LSX and a Y position of L/S pattern LSY which configure alignment mark AM) for the individual alignment marks AM subject to detection are detected. Then, main controller 120 obtains array coordinates of all the shot areas and amount of deformation (magnification, rotation, and orthogonal degree) including magnification of each shot on wafer W, by using a statistical method using the least squares method as is disclosed in, for example, U.S. Pat. No. 6,876,946 and the like (hereinafter, this alignment method will be referred to as an “in-shot multi-point EGA”).

Main controller 120 obtains a relative positional relation between the projection center of projection optical system PL and each shot area on wafer W, based on results of the wafer alignment measurement (in-shot multi-point EGA).

Main controller 120 monitors measurement results of reticle interferometer 14 and interferometer system 18, and moves reticle stage RST and wafer stage WST to each of their scanning starting positions (acceleration starting positions).

Main controller 120 relatively drives reticle stage RST and wafer stage WST in directions opposite to each other along the Y-axis direction. When reticle stage RST and wafer stage WST each reach their target speed, main controller 120 illuminates reticle R with illumination light IL. This begins the scanning exposure.

During the scanning exposure, main controller 120 controls reticle stage RST and wafer stage WST so that the velocity ratio of reticle stage RST and wafer stage WST is maintained corresponding to the velocity ratio of projection magnification β of projection optical system PL.

When the pattern of reticle R is transferred onto shot area S and alignment marks AM are transferred onto street SL, scanning exposure to one of the shot areas on wafer W is completed.

Main controller 120 moves (performs step movement) wafer stage WST to a scanning starting position (acceleration starting position) with respect to the next shot area.

Main controller 120 performs scanning exposure to the next shot area in the manner similar to the description above.

Hereinafter, main controller 120 repeatedly performs a stepping movement in between shot areas and scanning exposure to the shot area, so that the device pattern of reticle R is transferred to all the shot areas and alignment marks AM are transferred to street SL.

By repeating the exposure processing described above and device processing treatment such as etching and the like, a plurality of patterns are overlaid and formed on wafer W.

Now, as is shown in FIG. 4C, which is a sectional view of line B-B in FIG. 4B, street SL surrounding shot area S may be depressed with respect to shot area S.

An example of a relation between a position of the surface of wafer W in the Z-axis direction on exposure and a sensitized state of a resist layer will now be described, taking up a case when illumination light IL, which is shielded only by one line pattern of L/S pattern LSX in reticle R, is irradiated on a positive type resist layer CR on wafer W, via projection optical system PL. Incidentally, in the Z-axis direction, distance from a focal position of projection optical system PL will be expressed as ΔZ, the +Z side of the focal position of projection optical system PL will be expressed as “+”, and the −Z side will be expressed as “−”. Further, in the case of a positive type resist, the part exposed by light is removed by development, and the part which was not exposed to light remains on wafer W as a resist pattern.

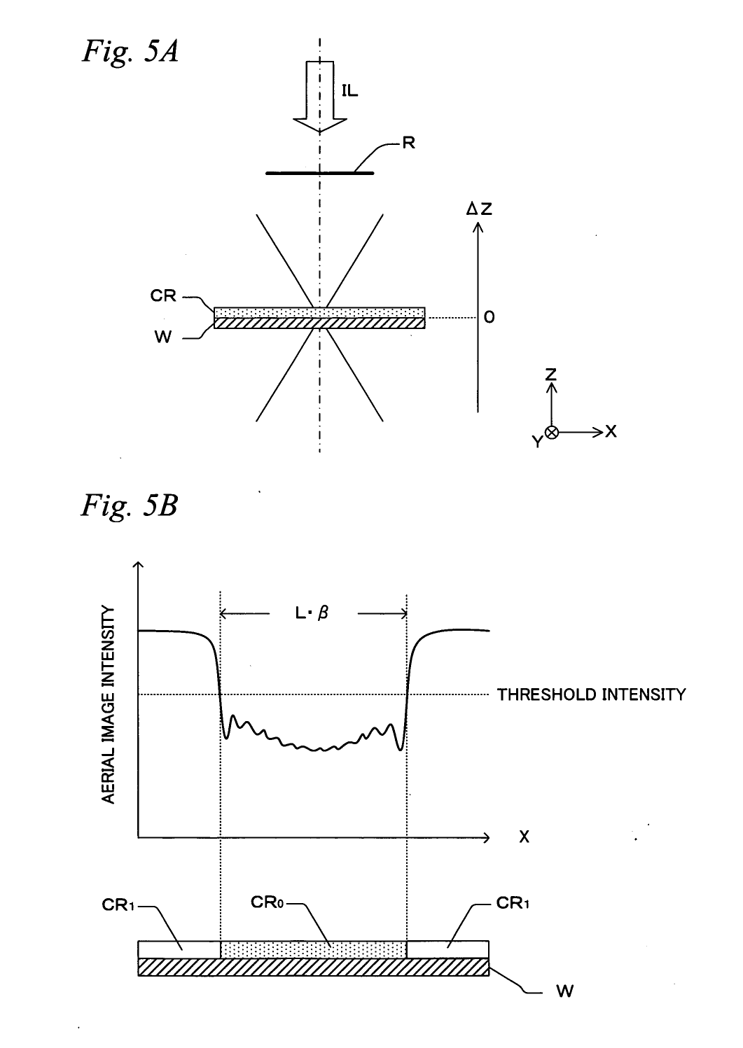

As shown in FIG. 5A, when the position of the surface of wafer W in the Z-axis direction coincides with the focus of projection optical system PL, or in other words, when defocus amount ΔZ=0, the aerial image intensity distribution shows a distribution of an approximately ideal depressed shape, as is shown as an example in FIG. 5B. However, the bottom section of the depressed shape in the aerial image intensity distribution shows a fine structure, coming from aberration, nontelecentricity, and illumination conditions and the like of projection optical system PL. In this case, in resist layer CR, portion CR₁, on which illumination light IL whose intensity exceeds a threshold intensity is irradiated, is exposed, and portion CR₀, on which illumination light IL whose intensity does not exceed the threshold intensity is irradiated, is not exposed. Therefore, the alignment marks are formed mostly without deformation.

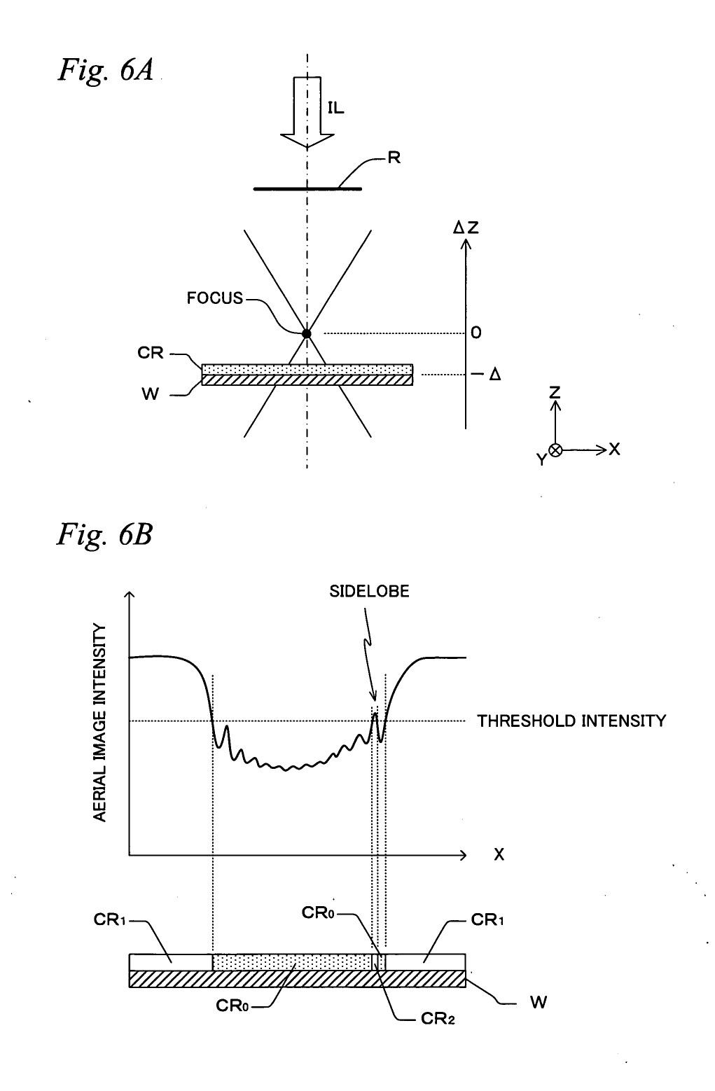

Meanwhile, when the surface of wafer W in the Z-axis direction is on the −Z side of the focus of projection optical system PL as shown in FIG. 6A, such as for example, ΔZ=−Δ, an aerial image intensity distribution shown in FIG. 6B can be obtained. When comparing this with when ΔZ=0 described above, the aerial image intensity distribution is distorted altogether, and the center shifts a little to the −X side. Furthermore, the bottom section of the aerial image intensity distribution shows a sidelobe on the +X side that has an intensity exceeding the threshold intensity. Accordingly, portion CR₂ corresponding to the sidelobe is exposed as well as portion CR₁, and a resist pattern including a defect coming from the sidelobe will be formed. As a result, alignment marks which are deformed and/or shifted are formed.

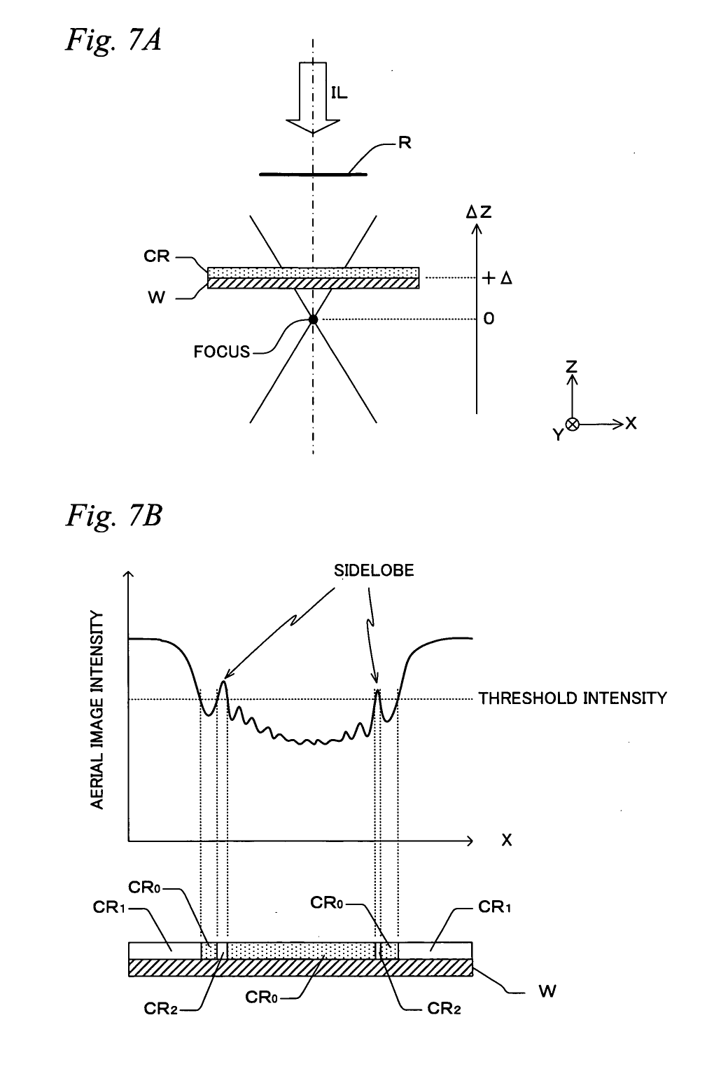

Further, when the surface of wafer W in the Z-axis direction is on the +Z side of the focus of projection optical system PL as shown in FIG. 7A, such as for example, ΔZ=+Δ, an aerial image intensity distribution shown in FIG. 7B can be obtained. When comparing this with when ΔZ=0 described above, the aerial image intensity distribution is distorted altogether, and the center shifts a little to the +X side. Furthermore, the bottom section of the aerial image intensity distribution also shows another sidelobe on the −X side that has an intensity exceeding the threshold intensity, as well as the sidelobe which has appeared on the +X side. Accordingly, two portions CR₂ corresponding to the sidelobes are exposed as well as portion CR₁, and a resist pattern including two defects coming from the sidelobes will be formed. As a result, alignment marks which are deformed and/or shifted are formed.

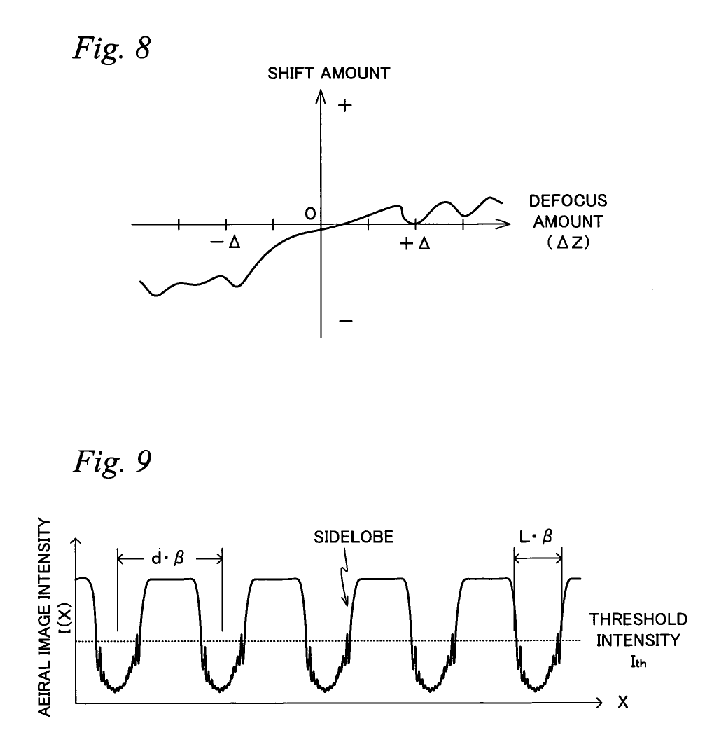

FIG. 8 shows a relation between a shift amount, which is a shift of a detection position of an alignment mark detected by alignment system AS from a design position, and defocus amount ΔZ. Incidentally, in FIG. 8, a shift to the +X direction is indicated as “+”, and a shift to the −X direction is indicated as “−”. According to this, to a small defocus amount ΔZ (=−0.5Δ to +0.5Δ), distribution of the aerial image intensity is distorted entirely along with defocusing (variation in ΔZ) and the center shifts, which moderately shifts the detection position of the alignment marks which are formed. In the case when ΔZ=0, it can be seen that the alignment marks are detected almost at the design position (slightly on the −X side).

Meanwhile, to a large defocus amount ΔZ (≦−0.75Δ and ≧+0.75Δ), sidelobes appear in the bottom section of the distribution as is shown in FIGS. 6B and 7B, and because the number of the sidelobes increases as well, the detection position of the alignment marks which are formed fluctuates greatly with respect to defocus amount ΔZ. In the case when ΔZ=−Δ (FIG. 6B), because the center of the aerial image intensity distribution shifts to the −X side with a sidelobe appearing on the +X side of the bottom section, the detection position of the alignment marks shifts greatly to −X side from the design position. Further, in the case when ΔZ=+Δ (FIG. 7B), because a sidelobe appears on the +X side of the bottom section, with yet another sidelobe appearing on the −X side, the shift amount conversely becomes smaller.

As is described so far, deformation and/or positional shift of alignment marks transferred in a defocused state occur, due to one of aberration, nontelecentricity, and illumination conditions and the like of projection optical system PL, or by two or more relating to each other. Now, when street SL is depressed, and a device pattern is transferred focusing on shot area S, for example, when ΔZ=−Δ as is described above, alignment marks AM are transferred onto street SL in a defocused state, and alignment marks AM will be detected at a position shifted to the −X side with respect to the design position. This becomes a cause of misdetection of the alignment marks in wafer alignment, or in other words, a cause of an overlay error.

Next, a method of designing an alignment mark whose deformation and shift are small (whose shift of the detection position detected by alignment detection system AS is small) even when being transferred in a defocused state will be described.

First of all, in consideration of optical properties of projection optical system PL, a shift (a lateral shift) in a direction (a direction intersecting optical axis AXp) parallel to the surface of wafer W is obtained of a projection position of an image of the pattern projected on wafer W and a projection position of an image of the alignment mark via projection optical system PL, with respect to a shift (longitudinal shift) in a direction parallel to optical axis AXp.

In this case, as the optical properties of projection optical system PL, aberration, telecentric nature (telecentricity), and the like are considered. The optical properties (such as aberration and telecentricity) are to be measured in advance, using an aerial image measuring instrument and the like installed in wafer stage WST or by using a test exposure method and the like which uses a reference wafer. Incidentally, aberration includes, as an example, spherical aberration (aberration of an image forming position), comatic aberration (aberration of magnification), astigmatism, curvature of field, distortion aberration (distortion) and the like.

A. In consideration of illumination conditions and the optical properties of projection optical system PL, an intensity distribution I(X) in the X-axis direction of the aerial image of L/S pattern LSX included in alignment marks AM formed on reticle R is calculated. In this case, intensity distribution I(X) is obtained for a plurality of different linewidths L and defocus amount ΔZ, respectively. Incidentally, because exposure apparatus 100 of the embodiment is an exposure apparatus by the step-and-scan method, intensity distribution I(X)=∫dYI (X, Y) of an aerial image in a direction besides the scanning direction (the X-axis direction) is to be obtained. Illumination conditions include, for example, a light source (wavelength characteristics such as the center wavelength of the illumination light, wavelength band and the like) to be used, illumination method (dipolar illumination, tripole illumination and the like), illuminance on the reticle and the wafer and the like. With these illumination conditions, normally, an illumination method is set according to the pattern which is to be formed on the wafer, and illuminance and the like are appropriately set according to characteristics (e.g. type, thickness of layer and the like) of the resist layer provided on the wafer.

When obtaining intensity distribution I(X) of the aerial image, the surface of shot area S on which the pattern is projected is to coincide with a focal position (or the best focus position) of projection optical system PL, and the surface of street SL on which alignment marks AM are projected, is to be depressed only by ΔZ with respect to the focal position of projection optical system PL. In this case, the longitudinal shift corresponds to a shift (to be referred to as defocus amount ΔZ) of the surface position of street SL on which images of alignment marks AM are projected from the focus (or the best focus position).

When defocus amount ΔZ=−Δ, intensity distribution I (X) which has been obtained here is shown in FIG. 9. Incidentally, reference code β in FIG. 9 is the projection magnification of projection optical system PL.

B. A shape distribution F(X) in the X-axis direction of alignment marks (hereinafter referred to as a “formation mark” for the sake of convenience) formed on street SL by transferring L/S pattern LSX is obtained from formula (1) below. Here, θ(I) is step function defined as in formula (2) below. Further, Iₜₕ indicates threshold intensity.

$$\begin{matrix}F ( X ) = θ ( \begin{matrix}- I & ( X ) & + {I}_{th}\end{matrix} ) & ( 1 ) ) \\ θ ( I ) = \{ \begin{matrix}1 & for & I \geq 0 \\ 0 & for & I < 0\end{matrix} & ( 2 )\end{matrix}$$

C. A center location X_{AM} of the formation mark is obtained from formula (3) below.

X_{AM}=∫dXF(X)·X/∫dXF(X) (3)

D. Lateral shift ΔX_{AM} of the formation mark is obtained from formula (4) below. Here, X_{AM0} is a designed center position of the formation mark. As this designed center position X_{AM0}, a center position which is obtained in an ideal state where there are no aberrations and nontelecentricity of projection optical system PL is used.

ΔX_{AM}=X_{AM}−X_{AM0} (4)

However, in the case the center position of the pattern (hereinafter also referred to as a “formation pattern” for the sake of convenience) formed on shot area S is shifted with respect to the center position in the ideal state, a relative lateral shift ΔX_{AM′} is obtained from formula (5) below. In this case, ΔX_{S} is a shift of the center position of the formation pattern. This ΔX_{S} is obtained in a similar manner as lateral shift ΔX_{AM} of the formation mark, however, with respect to only defocus amount ΔZ=0.

ΔX_{AM′}=X_{AM}−X_{AM0}ΔX_{S} (5)

Now, to be exact, a shift of distance from the designed distance has to be considered for the distance from the center position of the formation pattern to the center position of the formation mark, however, in the case the surface of shot area S coincides with the focal position of projection optical system PL, the shift can be substituted by lateral shift ΔX_{AM} of the formation mark.

By obtaining lateral shift ΔX_{AM} or relative lateral shift ΔX_{AM′}, for example, with respect to defocus ΔZ within a range of the depth of focus of projection optical system PL, lateral shift ΔX_{AM}(ΔZ) or relative lateral shift ΔX_{AM′}(ΔZ) serving as a function of defocus ΔZ can be obtained.

E. Next, design conditions of alignment marks AM are optimized, based on lateral shift ΔX_{AM}(ΔZ) or relative lateral shift ΔX_{AM′}(ΔZ) which have been obtained. Now, the design conditions include, for example, at least one of a type of mark, shape, position (image height) and the like. In the embodiment, as an example, the type of mark is an L/S pattern, and a position shown in FIG. 3A is considered as the position (image height). In the case of an L/S pattern, design conditions for its shape include linewidth L of the line pattern, a pitch d and the like. As an example, here, linewidth L of the line pattern configuring the L/S pattern is to be optimized, under such conditions of the type of mark, the position (image height) and the like.

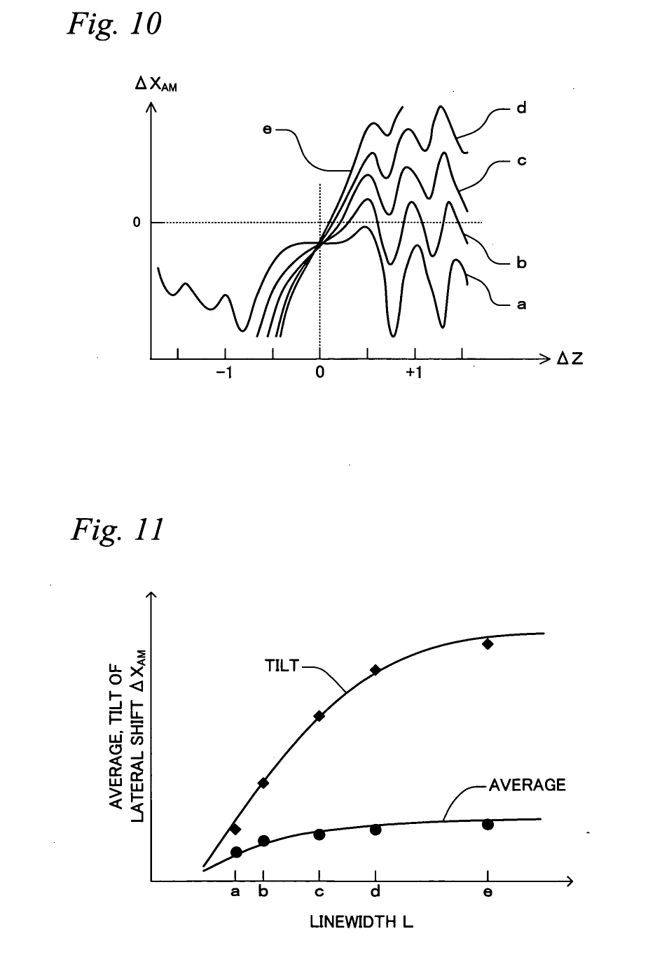

FIG. 10 shows a relation between lateral shift ΔX_{AM} which has been obtained and defocus amount AZ for five types (a<b<c<d<e) of L/S patterns LSX each having a different linewidth L. According to this, in the case defocus amount ΔZ is −0.5Δ to +0.5Δ, the intensity distribution is distorted altogether, and because the center shifts, lateral shift ΔX_{AM} changes gradually with respect to defocus amount ΔZ. Further, when defocus amount ΔZ is equal to, or less than −0.75Δ, and equal to, or more than +0.75Δ, a sidelobe appears at the bottom section of the intensity distribution which has an intensity exceeding threshold intensity Iₜₕ, and furthermore, when the absolute value of defocus amount ΔZ becomes larger, the number of sidelobes also increases, which makes lateral shift ΔX_{AM} fluctuate greatly with respect to defocus amount ΔZ.

Further, while the behavior of lateral shift ΔX_{AM} to defocus amount ΔZ is almost the same even if linewidth L is different, it can be seen that when linewidth L increases, the degree of variation increases. FIG. 11 shows an average of lateral shift ΔX_{AM}(ΔX_{AM}(ΔZ=0)) and a tilt (dΔX_{AM}/dΔZ|_{ΔX=0}) when defocus amount is ΔZ=0 with respect to linewidth L. As it can be seen, while the average is substantially constant with respect to linewidth L, the tilt is large when linewidth L increases. Therefore, linewidth a, whose average is the smallest and also having the smallest tilt is chosen as the optimum condition of linewidth L.

F. The optimum condition is obtained in a procedure similar to the one described in A. to E. above for other design conditions regarding alignment marks AM, for every illumination condition.

G. Furthermore, in order to design a more optimal alignment mark AM, detection conditions for detecting alignment marks AM formed on wafer W using alignment detection system AS are considered. Detection conditions include an irradiation condition of the detection light irradiated on alignment mark AM, such as for example, at least one of intensity, wavelength characteristic, illumination distribution and the like. According to such detection conditions, input to alignment detection system AS, or in other words, a response function φ(X) is determined, which indicates a response of detection results (signal intensity) f(X) of alignment detection system AS with respect to shape distribution F(X) (refer to formula (1) previously described) of alignment marks AM. In this case, signal intensity f(X) can be obtained as in formula (6) below, using shape distribution F(X) and response function φ(X).

f(X)=∫dX′φ(X−X′)/F(X′) (6))

Incidentally, it is possible to empirically obtain response function φ(X) by detecting alignment marks AM having an ideal shape distribution F₀(X) using alignment detection system AS, and applying detection results (signal intensity) f(X) which have been obtained to formula (6).

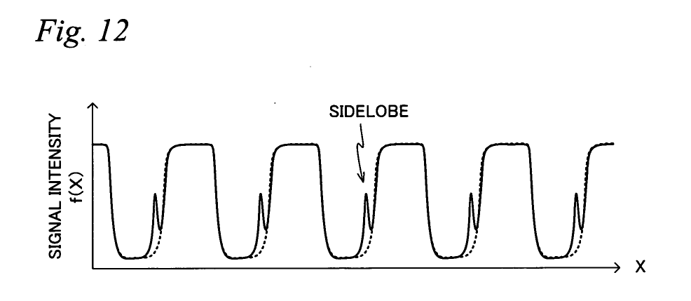

Using formula (6), detection results (signal intensity) f(X) by alignment detection system AS are obtained from shape distribution F(X) of alignment marks AM which has been obtained earlier. FIG. 12 shows an example of signal intensity f(X) which has been obtained. In signal intensity f(X), five successive bottom sections appear corresponding to the five line patterns configuring alignment marks AM. Furthermore, a sidelobe corresponding to the defect of the line pattern appears in the individual bottom sections.

Using signal intensity f(X), detection position x_{AM} of alignment marks AM (L/S pattern LSX) expressed in formula (7) below is obtained, and then, from a shift of detection position x_{AM} from the designed center position X_{AM0}, lateral shift Δx_{AM} expressed in formula (8) below is obtained.

x_{AM}=∫dXf(X)·X/∫dXf(X) (7)

Δx_{AM}=x_{AM}−X_{AM0} (8)

Further, in the case the center position of the pattern shifts from the center position in the ideal state as is previously described, relative lateral shift Δx_{AM′} is obtained, using formula (9) below.

Δx_{AM′}=x_{AM}−X_{AM0}−Δx_{S} (9)

Shift Δx_{S} of the center position of the pattern can be obtained, in a manner similar to lateral shift Δx_{AM}. However, shift Δx_{S} is obtained, with respect to only defocus ΔZ=0.

By alternatively using lateral shift Δx_{AM} or relative lateral shift Δx_{AM′} instead of lateral shift ΔX_{AM} or relative lateral shift ΔX_{AM′} which are previously described, design conditions of alignment marks AM are optimized.

H. Optimization of design conditions is performed similarly on all of the design conditions, for each illumination condition and each detection condition.

I. The optimum condition of linewidth L is obtained similarly for L/S pattern LSY, which is another pattern included in alignment marks AM.

By forming alignment marks AM that satisfy the optimum condition obtained in the manner described above on reticle R, alignment marks whose deformation and positional shift are small even when the marks are transferred in a defocused state can be formed on street SL.

As described above, according to exposure apparatus 100 related to the embodiment, lateral shift (ΔX_{AM} or Δx_{AM}) of the image of alignment marks AM projected on wafer W is obtained, taking into consideration the illumination condition and the optical properties of projection optical system PL, and the design conditions of alignment marks AM formed on reticle R is optimized, based on the lateral shift (ΔX_{AM} or Δx_{AM}). In this case, even if the marks are transferred on wafer W in a defocused state, deformation and positional shift of the alignment marks formed on wafer W can be reduced. Accordingly, each of the plurality of shot areas on wafer W can be aligned with high precision to a predetermined position, such as, for example, the projection position of the pattern of reticle R, which allows the overlay accuracy to be improved.

Incidentally, in the embodiment above, a negative type resist can be used instead of the positive type resist. In this case, formula (10) below is used, instead of formula (1) referred to above.

F(X)=θ(I(X)−Iₜₕ) (10)

Further, in the embodiment above, when a different illumination condition is used for each type of reticle, the optimum condition is obtained for each illumination condition.

Further, in the embodiment, when a plurality of reticles are prepared whose illumination condition is different from each other, main controller 120 selects a reticle in which the most suitable alignment marks AM corresponding to the illumination condition of exposure apparatus 100 are provided. Further, a host computer which has overall control over a device manufacturing system including exposure apparatus 100 can select a reticle in which the most suitable alignment marks AM corresponding to the illumination condition of exposure apparatus 100 are provided.

Further, in the embodiment described above, it is also effective to perform exposure using a reticle (hereinafter referred to as a stepped reticle) which has a two-stepped structure with alignment marks formed on a stepped section whose surface position differs from a pattern section (pattern area) on which device patterns are formed, and to optimally design the alignment marks formed in the stepped section. In this case, the difference (step) between the pattern section and the surface position of the stepped section should be chosen to satisfy ΔZ_{R}=ΔZ_{W}/nβ². Here, ΔZ_{W} indicates the depth of a recess within the street on the wafer, and β is the projection magnification of the projection optical system. Further, n is a refractive index of a medium on the image side, and in the case of a dry type exposure apparatus in the embodiment described above, the atmospheric refractive index n=1.0, and in the case of a wet type exposure apparatus which exposes a wafer via a liquid (water) and will be described later on, the liquid (water) refractive index n=1.44.

### A Second Embodiment

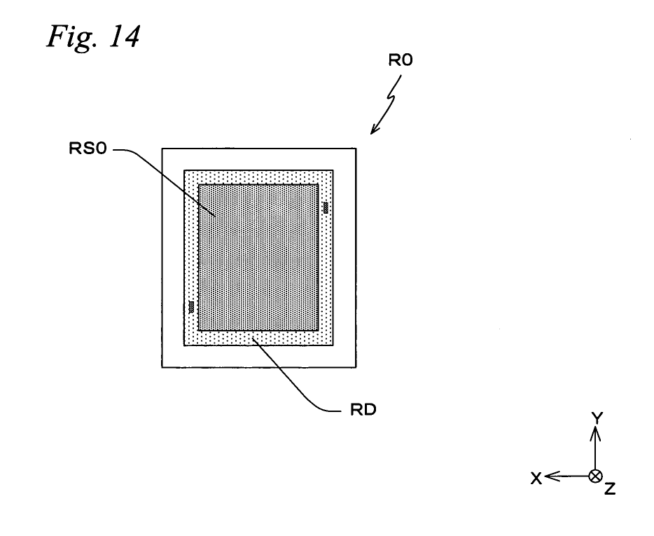

Next, an exposure method and a device manufacturing method related to a second embodiment of the present invention are described, referring to FIGS. 14A to 16D. In the second embodiment, exposure apparatus 100 which has been previously described is used. In this case, from a viewpoint of avoiding repetition, description on configuration and the like of the apparatus will be omitted. Further, the same reference numeral will be used for the same section.

In the second embodiment, in order to reduce the occurrence of an exposure error due to a step between a shot area (formation area of a pattern) and a street (formation area of an alignment mark and the like) on the wafer, main controller 120 performs correction of detection results of alignment marks in the manner described below.

a. First of all, in a procedure similar to the one described in A. to G. earlier in the first embodiment, lateral shift ΔX_{AM} or Δx_{AM}, or relative lateral shift ΔX_{AM′} or Δx_{AM′} is obtained for a plurality of different ΔZs, regarding alignment marks (formation marks) formed on street SL and a pattern (formation pattern) formed in shot area S by transferring L/S pattern LSX.

When there is a plurality of design conditions for alignment marks AM, intensity distribution I (X) of the aerial image is obtained further for each of the design conditions. The design conditions include, for example, at least two of a type of mark, shape, position (image height) and the like. For example, in the case of an L/S pattern, design conditions for its shape include linewidth L of the line pattern, a pitch d and the like. Further, intensity distribution Δ(X) is obtained for each of a plurality of defocus amounts ΔZ. In this case, however, because the recess within street SL to shot area S on the wafer is addressed, only defocus area ΔZ≦0 should be considered.

By obtaining a lateral shift or a relative lateral shift with respect to defocus ΔZ (provided ΔZ≦0) within a range the depth of focus of projection optical system PL, lateral shift ΔX_{AM}(ΔZ) or Δx_{AM}(ΔZ), or relative lateral shift ΔX_{AM′}(ΔZ) or Δx_{AM′}(ΔZ) serving as a function of defocus ΔZ can be obtained.

b. Also for the other L/S pattern LSY included in alignment marks AM, lateral shift ΔY_{AM}(ΔZ) or Δy_{AM}(ΔZ), or relative lateral shift ΔY_{AM′}(ΔZ) or ΔY_{AM}(ΔZ) serving as a function of defocus ΔZ is obtained in a similar manner.

c. Lateral shift ΔX_{AM}(ΔZ), ΔY_{AM}(ΔZ) or Δx_{AM}(ΔZ), Δy_{AM}(ΔZ), or relative lateral shift ΔX_{AM′}(ΔZ), ΔY_{AM′}(ΔZ) or Δx_{AM′}(ΔZ), Δy_{AM′}(ΔZ) that have been obtained are made to correspond to the illumination conditions, design conditions of the alignment marks, detection conditions of alignment system AS and the like, and are saved in a memory (not shown).

d. In the exposure process, when alignment detection system AS is used to detect an alignment mark formed on wafer W, a surface position of shot area S and street LS (position in the Z-axis direction of each of their surfaces) is measured using a focus detection system equipped in each of focus sensor AF and alignment detection system AS. Then, a depth ΔZ of the recess of street SL is obtained, with the surface position of shot area S as a reference is obtained.

e. Lateral shiftΔX_{AM}(ΔZ), ΔY_{AM}(ΔZ) or Δx_{AM}(ΔZ), Δy_{AM}(ΔZ), or relative lateral shift ΔX_{AM′}(ΔZ), ΔY_{AM′}(ΔZ) or Δx_{AM′}(ΔZ), Δy_{AM′}(ΔZ) corresponding to the exposure conditions (illumination conditions included in the exposure conditions, design conditions of alignment marks formed on reticle R which is to be used, detection conditions of alignment detection system AS and the like) to wafer W at that point of time, are read from the memory (not shown), and using the lateral shift or relative lateral shift which has been read, lateral shift ΔX_{AM}(ΔZ), ΔY_{AM}(ΔZ) or Δx_{AM}(ΔZ), Δy_{AM}(ΔZ), or relative lateral shift ΔX_{AM′}(ΔZ), ΔY_{AM′}(ΔZ) or Δx_{AM′}(ΔZ), Δy_{AM′}(ΔZ) of the alignment marks corresponding to depth ΔZ of the recess of street SL is obtained.

f. Detection results of alignment marks AM are corrected, with lateral shift ΔX_{AM}(ΔZ), ΔY_{AM}(ΔZ) or Δx_{AM}(ΔZ), Δy_{AM}(ΔZ) or relative lateral shift ΔX_{AM′}(ΔZ), ΔY_{AM′}(ΔZ) or Δx_{AM′}(ΔZ), Δy_{AM′}(ΔZ) which have been obtained serving as correction values.

As discussed above, according to the exposure method related to the second embodiment, by obtaining lateral shift ΔX_{AM}(ΔZ), ΔY_{AM}(ΔZ) or Δx_{AM}(ΔZ), Δy_{AM}(ΔZ), or relative lateral shift ΔX_{AM′}(ΔZ), ΔY_{AM′}(ΔZ) or Δx_{AM′}(ΔZ), Δy_{AM′}(ΔZ) in advance and measuring the surface position of street SL whose reference is the surface position of shot area S when detecting the alignment marks formed on wafer W in the exposure process, detection results of the alignment marks, such as, for example, EGA parameters (offset, X scaling, and orthogonal degree) can be corrected, using lateral shift ΔX_{AM}, ΔY_{AM} or Δx_{AM}, Δy_{AM}, or relative lateral shift ΔX_{AM′}, ΔY_{AM′} or ΔX_{AM′}, Δy_{AM′} corresponding to the longitudinal shift (defocus amount ΔZ) obtained from the measurement results. In this case, detection errors of the alignment marks associated with the recess of street SL can be corrected. Accordingly, each of the plurality of shot areas on wafer W can be aligned with high precision to a predetermined position, such as, for example, the projection position of the pattern of reticle R, which allows the overlay accuracy to be improved.

Incidentally, in the second embodiment described above, instead of directly correcting the detection results of the alignment marks using lateral shift ΔX_{AM}, ΔY_{AM} or Δx_{AM}, Δy_{AM}, or relative lateral shift ΔX_{AM′}, ΔY_{AM′} or Δx_{AM′}, Δy_{AM′}, the position of shot area S on wafer W, magnification, and orthogonal degree which are obtained from the results of baseline measurement or the detection results of the alignment marks can be corrected.

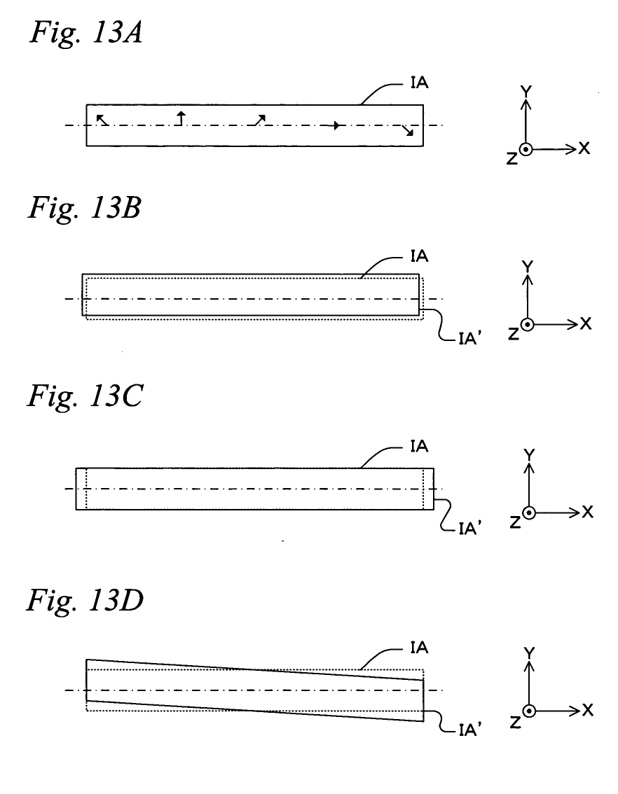

In this case, as shown in FIG. 13A, lateral shift ΔX_{AM}, ΔY_{AM} or Δx_{AM}, Δy_{AM} or relative lateral shift ΔX_{AM′}, ΔY_{AM′} or Δx_{AM′}, Δy_{AM′} are obtained for a plurality of positions in the X-axis direction within exposure area IA. FIG. 13A shows lateral shift ΔX_{AM}, ΔY_{AM} or Δx_{AM}, Δy_{AM} which are obtained at five positions, each indicated using a vector. By using these results, offset (shift of position), magnification (X scaling), and orthogonal degree that indicate the lateral shift of exposure area IA are obtained, in a manner similar to obtaining the position, magnification and orthogonal degree of shot area S. These offsets, magnification, and the orthogonal degree are obtained for a plurality of different ΔZs, and are saved in memory.

FIG. 13B shows an exposure area IA′ which has shifted laterally only by an offset. Further, FIG. 13C shows exposure area IA′ which has shifted laterally only by magnification. And, FIG. 13D shows exposure area IA′ which has shifted laterally only by an orthogonal degree.

In wafer alignment with respect to wafer W, main controller 120 corrects the position, magnification, and orthogonal degree of shot area S, with the values of offset, magnification, and orthogonal degree corresponding to the depth of the recess of street SL serving as the correction values.

Incidentally, because this correction is performed assuming that the lateral shift of exposure area IA shown in FIG. 13A is equally reflected on the entire surface of wafer W, the depth of the recess of street SL needs to be almost equal at least for all the alignment marks detected in the wafer alignment measurement (such as, in-shot multi-point EGA).

Now, in drive control of wafer stage WST by stage drive system 24, an alignment error (a so-called focus error) of wafer W in the Z-axis direction may occur. In this case, the assumption referred to above, in other words, the assumption that the surface position of shot area S on wafer W on which the image of the pattern is projected coincides with the focus (or the best focus position) of projection optical system PL, does not necessarily stand. Therefore, lateral shift ΔX_{AM} should be obtained as a function of the depth of the recess in street SL, with the surface position of shot area S in the Z-axis direction and the surface position of shot area S serving as a reference. And when a variation of lateral shift ΔX_{AM} with respect to the surface position of shot area S is not that large, lateral shift ΔX_{AM} can be averaged for the surface position of shot area S, and the average value of lateral shift ΔX_{AM} which has been obtained can be used instead of lateral shift ΔX_{AM} described above.

In the second embodiment, instead of correcting the detection results of the alignment marks using the lateral shift, the relative lateral shift, or the average value of the lateral shift, results of the baseline measurement, or EGA results such as the position of shot area S on wafer W obtained from the detection results of the alignment marks, magnification, orthogonal degree and the like can be corrected. Besides this, a positional relation between a reference mark and a wafer mark can be corrected.

### A Third Embodiment

Next, an exposure method and a device manufacturing method related to a third embodiment of the present invention are described, referring to FIGS. 14A to 16D. In the third embodiment, exposure apparatus 100 which has been previously described is used. In this case, from a viewpoint of avoiding repetition, description on configuration and the like of the apparatus will be omitted. Further, the same reference numeral will be used for the same section.

In the third embodiment, a dummy-pattern exposure and re-formation of alignment marks are to be performed in order to avoid misdetection of alignment marks.

In response to instructions of main controller 120, as an example, reticle R0 shown in FIG. 14A is mounted on reticle stage RST by a reticle loader (not shown). Reticle R0 has a pattern area RS0 including a device pattern, and a dummy pattern area RD on which a dummy pattern is formed that surrounds pattern area RS0, formed on a glass substrate. Dummy pattern area RD has a shape and size corresponding to street SL. And, in reticle R0, pattern area RS0 consists of a light shielding section which has a device pattern consisting of a light transmitting section formed inside, and dummy pattern area RD is a light shielding section.

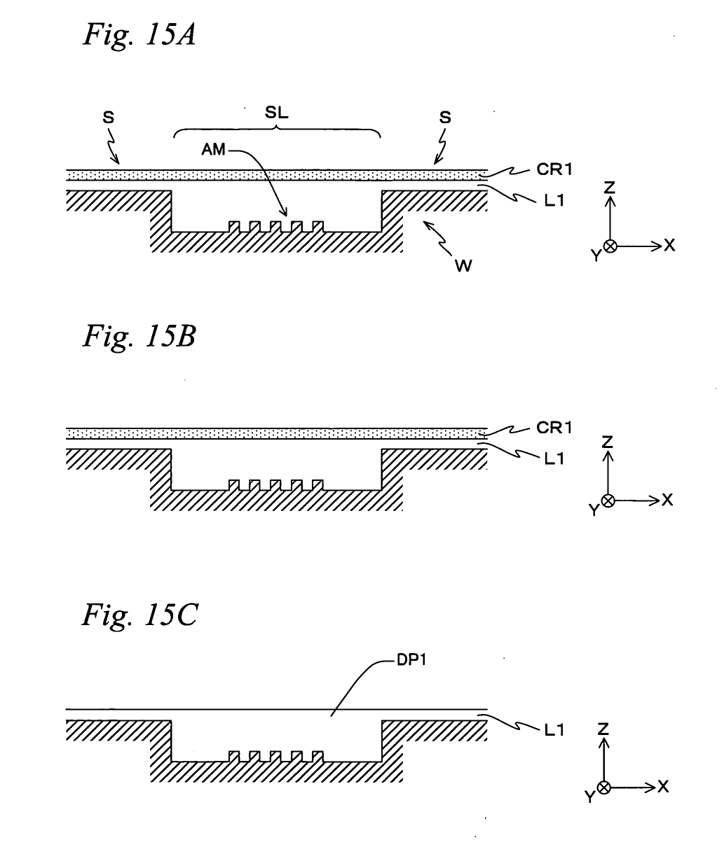

As shown in FIG. 15A, a function membrane L1 such as a conductive thin film or an insulating thin film, and a positive type resist film (a resist layer) CR1 are layered on the surface of wafer W. Incidentally, in street SL, alignment marks AM are to be formed. Such a wafer W is carried into exposure apparatus 100, placed on a wafer holder mounted on wafer stage WST, and is held by suction.

Main controller 120 detects alignment marks AM of street SL using alignment detection system AS, via resist layer CR₁ and function membrane L1, and performs wafer alignment (as in the in-shot multi-point EGA, or the EGA disclosed in, for example, U.S. Pat. No. 4,780,617 and the like).

Main controller 120 sequentially performs scanning exposure on all the shot areas on wafer W, based on results of the wafer alignment. In this case, because dummy pattern area RD is a light shielding section, illumination light IL is not irradiated on resist layer CR1 of street SL.

When scanning exposure is completed on all the shot areas, wafer W is developed. By this development, the portion exposed to light of resist layer CR1 formed on wafer W is dissolved, and the remaining portion remains on the wafer surface as a resist pattern. Accordingly, each shot area S on wafer W is covered with a resist pattern having an aperture (a groove portion) which is the same as the device pattern of reticle R0, and street SL is completely covered with a resist pattern without any apertures as shown in FIG. 15B.

When the development is completed, an etching process is performed on function membrane L1 with the resist pattern serving as an etching mask, and then, resist layer CR1 is further removed. This forms a pattern the same as the device pattern of reticle R0 in function membrane L1 on shot area S. Meanwhile, as is shown in FIG. 15C, function membrane L1 on street SL is embedded in a recess that was generated in street SL as a dummy pattern DP1, without being etched.

This makes the surface of function membrane L1 on shot area S and the surface of dummy pattern DP1 substantially flush, and the surface of wafer W becomes flat. In this case, when a plurality of layers on which formation of alignment marks are not performed continue, the surface may not become flat in a single dummy pattern exposure. In such a case, the exposure should be repeated a plurality of times, until the surface becomes flat enough. As a matter of course, the surface should be flat enough (a step between the shot area surface and the recess generated in street LS should be small) so that the misdetection of the alignment marks which are formed in a deformed manner by defocus can be ignored.

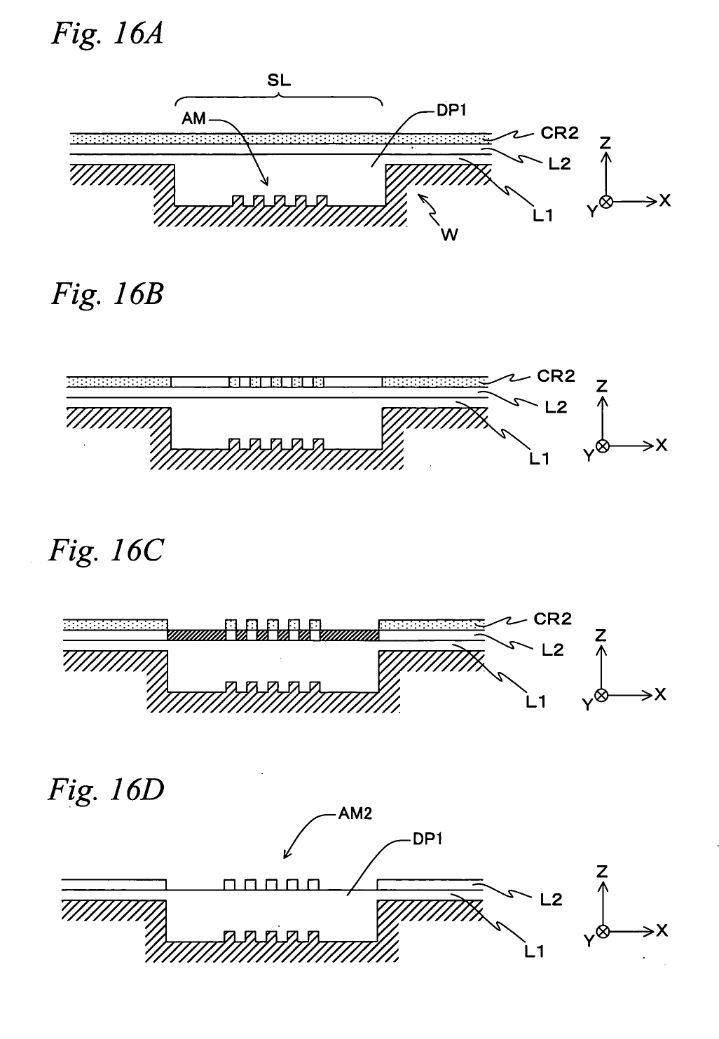

On exposure of the next layer (exposure accompanied with transferring and forming alignment marks), as shown in FIG. 16A, function membrane L2 and a positive type resist film (a resist layer). CR2 are layered, on the surface of wafer W on which dummy pattern DP1 is formed. Such a wafer W is carried into exposure apparatus 100, placed on a wafer holder mounted on wafer stage WST, and is held by suction.

Main controller 120 detects alignment marks AM of street SL using alignment detection system AS, via function membrane L2 and dummy pattern DP1, and performs wafer alignment.

Main controller 120 performs scanning exposure on all the shot areas, based on results of the wafer alignment. This allows the device pattern of reticle R to be transferred on resist layer CR2 on shot area S, and on resist layer CR2 on street SL, alignment marks AM of reticle R are transferred, as shown in FIG. 16B.

When scanning exposure is completed on all the shot areas, wafer W is developed. By this development, the portion exposed to light of resist layer CR2 formed on wafer W is dissolved, and the remaining portion which has not been exposed remains on the wafer surface as a resist pattern. Accordingly, shot area S is covered with a resist pattern having an aperture (a groove portion) which is the same as the device pattern of reticle R, and a part of street SL is covered only by a resist pattern corresponding to alignment marks AM, as shown in FIG. 16C.

When the development is completed, an etching process is performed on function membrane L2 with the resist pattern serving as an etching mask, and the portion which is not covered with the resist pattern is etched. Furthermore, resist layer CR2 is removed. This forms a pattern the same as the device pattern of reticle R in function membrane L2 on shot area S, and on dummy pattern DP1 of street SL, a part of function membrane L2 which has remained without being etched is formed as new alignment marks AM2, as shown in FIG. 16D.

Then, in the exposure process thereinafter, a wafer alignment (such as in-shot multi-point EGA) is performed using the new alignment marks AM2. Incidentally, in the case a part of alignment marks AM which has already been formed earlier can be used, it is also possible to perform wafer alignment using such alignment marks AM and alignment marks AM2 which have been newly formed.

As described above, according to the third embodiment, dummy pattern DP1 is formed on street SL where alignment marks AM are formed to make wafer W flat, and new alignment marks AM2 are formed on dummy pattern DP1. In this case, alignment marks AM2 are formed on wafer W without deformation by defocus. Accordingly, misdetection of the alignment marks on wafer alignment can be avoided, and it becomes possible to maintain sufficient overlay accuracy.

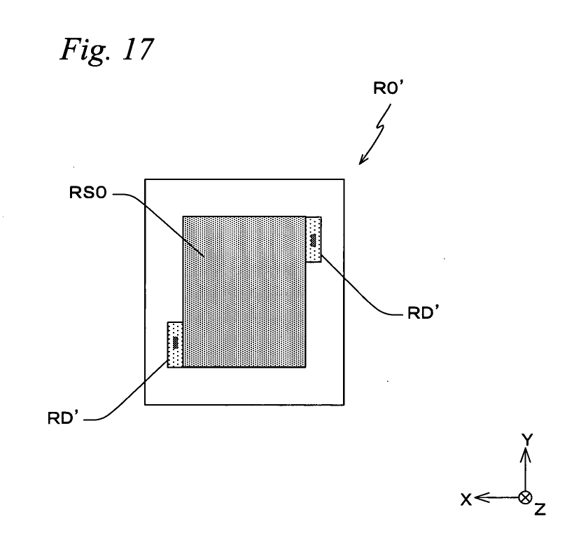

Incidentally, in the dummy-pattern exposure of the third embodiment, the dummy pattern can be formed only in a part of street SL. In this case, instead of reticle R0, reticle R0′ shown in FIG. 17 can be used as an example. With this reticle R0′, dummy pattern area RD′ on which the dummy pattern is formed is provided only in the vicinity of an area corresponding to the area where alignment marks AM of reticle R are formed.

Further, instead of the dummy-pattern exposure of the third embodiment, only a dummy pattern can be formed. In such a case, a reticle on which a dummy pattern area RD or RD′ and a pattern area whose entire surface consists of a light shielding pattern are formed can be used. In this case, when the surface does not become flat in one dummy-pattern exposure, the exposure should be repeated a plurality of times, until the surface becomes flat enough. As a matter of course, the surface should be flat enough so that the misdetection of the alignment marks which are formed in a deformed manner by defocus can be ignored. In addition, for example, only a dummy pattern can be formed in the street on the wafer using and electron beam exposure apparatus, or the portion where the dummy pattern is formed can be embedded with a predetermined material. In other words, a flattening treatment of flattening a target portion of at least a part of a recess portion (street) dividing a plurality of shot areas (divided areas) on a wafer and a shot area portion should be applied. Incidentally, when only the flattening treatment (including formation of the dummy pattern) is performed without the pattern transfer, the dummy pattern can be formed in the street on the wafer just before exposure is performed on the layer which requires transfer of alignment marks. Incidentally, as a material of the dummy pattern, it is not necessary to use a function membrane such as a conductive thin film or an insulating thin film.

Further, in the third embodiment above, instead of the dummy-pattern exposure, an exposure in which a part (equivalent to a target portion in at least a part of the street) of the positive type resist is an unexposed portion can be performed. Further, a negative type resist may be used as well as the positive type resist. In this case, instead of reticle R0, a reticle is used whose dummy pattern area RD is a light transmitting section, and the area besides pattern area RS0 and dummy pattern area RD is a light shielding section.

Further, in the third embodiment above, while the case has been described where new alignment marks AM2 were overlaid on alignment marks AM; the present invention is not limited to this. For example, if the position where the new alignment marks AM2 are to be formed is determined, the new alignment marks AM2 can be formed overlaying only on a part of alignment marks AM, or dummy pattern DP1 which is formed at an arbitrary position can be overlaid.

Further, instead of, or together with the exposure of the dummy pattern of the third embodiment described above, the exposure can also be performed using the stepped reticle that was previously described. In this case as well, the difference (step) between the pattern section and the surface position of the stepped section should be chosen to satisfy ΔZ_{R}=ΔZ_{W}/(nβ²).

Further, in the third embodiment described above, the recess (step information) of the surface of wafer W can be detected beforehand prior to the beginning of exposure, for example, using focus sensor AF and the like, and the position to provide dummy pattern DP1 and new alignment marks AM2 can be decided, based on the results. In this case, when the depth of the recess exceeds a predetermined depth, the dummy-pattern exposure describe above can be performed so as to form new alignment marks.

Further, the dummy-pattern exposure described above can be performed, each time a predetermined plurality of layers of patterns are overlaid and formed.

Further, in the third embodiment described above, when detecting alignment marks AM already formed in street SL via dummy pattern DP1 using alignment detection system AS, detection conditions of alignment detection system AS such as, for example, intensity of the detection light, wavelength, beam size and the like can be optimized, taking into consideration the material, thickness and the like of dummy pattern DP1.

Incidentally, the dummy-pattern exposure does not necessarily have to be performed via an exposure apparatus, namely a projection optical system, and as is previously described, and another device or a dummy pattern exposure module (unit) can be installed inside the exposure apparatus at a predetermined position (for example, an unloading path of the wafer and the like). In this dummy pattern exposure module, for example, a spatial light modulator and the like can be used as a pattern generator. Further, in the embodiment above, while the case has been described where a street is recessed with respect to a shot area (pattern formation area), the opposite, or in other words, the shot area being recessed with respect to the street is also possible. The important point is, as long as there is a level difference between the area where the alignment marks are formed and the area where the pattern is formed, each of the first to third embodiments described above can be suitably applied.

Incidentally, in the first embodiment previously described, as well the optimal design of the alignment marks as is previously described, detection results of alignment marks AM can also be corrected using lateral shift ΔX_{AM}(ΔZ) or Δx_{AM}(ΔZ) which are obtained in the optimal design. This allows an even greater accuracy in the overlay accuracy (alignment) of the pattern. In the correction of the detection results of alignment mark AM in this case, first of all, the surface position is measured for shot area S on which the pattern of wafer W is formed and for street SL on which alignment marks AM are arranged using focus sensor AF and the focus detection system equipped in alignment detection system AS, respectively, when alignment marks AM are detected using alignment detection system AS, and depth ΔZ of the recess of street SL is obtained, with the surface position of shot area S serving as a reference. Next, from the lateral shift obtained in the optimal design of the alignment marks, a lateral shift is selected corresponding to the exposure conditions (illumination conditions and the like) of wafer W and the detection conditions of alignment detection system AS. Lateral shift ΔX_{AM}(ΔZ) or Δx_{AM}(ΔZ) of the alignment marks corresponding to depth ΔZ is obtained, using the lateral shift which has been selected. Finally, the detection results of alignment marks AM are corrected, using the lateral shift which has been obtained as the correction values. Or, the results of base line measurement, or the EGA parameters can also be corrected. This even cancels an overlay (alignment) error originating from a fine deformation (lateral shift) in the alignment marks which are optimally designed.

Further, in the first embodiment previously described, the wafer W surface should be flattened as much as possible, such as by forming a dummy pattern on street SL which is generated recessed on wafer W as in the third embodiment described above. Then, new alignment marks should be formed on street SL which has been completely or roughly flattened, and it is also effective to optimally design the alignment marks that are newly formed. In this case, the lateral shift which comes with the defocus of the alignment marks that are formed is canceled by flattening the wafer W surface, and the remaining lateral shift which comes with the distortion of the projection optical system is canceled by the optimum design of alignment marks. The alignment marks which are optimally designed in the manner described above are formed on street SL, and alignment measurement is performed, using such alignment marks. Furthermore, the detection result of the alignment marks are corrected using lateral shift ΔX_{AM}ΔZ) or Δx_{AM}(ΔZ) obtained in the optimal design. This allows an even greater accuracy in the overlay accuracy (alignment) of the pattern.

Further, in the first embodiment previously described, the wafer W surface (the surface of a street and shot areas divided by the street) should be flattened as much as possible, such as by forming a dummy pattern on street SL which is generated recessed on wafer W as is previously described in the third embodiment, and then, new alignment marks should be formed on street SL which has been completely or roughly flattened, and it is also effective to correct the detection errors of the alignment marks which are newly formed. In this case, the lateral shift which comes with the defocus of the alignment marks that are formed is canceled by flattening the wafer W surface, and the remaining lateral shift which comes with the distortion of the projection optical system is canceled by the correction. Therefore, an even greater accuracy in the overlay accuracy (alignment) of the pattern becomes possible.

Further, in the third embodiment previously described, in combination with the dummy-pattern exposure, alignment marks whose deformation of the transferred image due to defocus is small can be designed as in the first embodiment previously described, and exposure (transfer of a pattern) can be performed using a reticle on which the designed alignment marks are formed. For example, in consideration of optical properties such as aberration, telecentricity of projection optical system PL, the shift amount of the projection position of the image of the alignment marks projected on the wafer via the projection optical system can be obtained with respect to defocus, and the type, shape, formation position and the like of the alignment marks can be optimized so that the shift amount obtained is minimized, or that the degree of variation of the shift amount with respect to defocus is minimized. However, it is assumed that the surface position of the shot area on wafer W on which the pattern is projected coincides with the focus of the projection optical system. Furthermore, the illumination conditions of the reticle and the wafer, the detection conditions of alignment detection system AS and the like should also be considered. This allows misdetection of the alignment marks, or in other words, generation of overlay errors to be further avoided.

Incidentally, the placement of the alignment marks described in the first to third embodiments above is a mere example, and, for example, as for the alignment marks, the number of marks should be one or more, with the shape and the like arbitrary. Further, the alignment marks may be formed not only in the street line, but also in the shot area.

Further, in each of the first to third embodiments described above, as the wafer alignment, an EGA which is disclosed in, for example, U.S. Pat. No. 4,780,617 and the like can be performed, instead of the in-shot multi-point EGA, and in this case, measuring just one alignment mark in one shot area will be acceptable.

Further, of the first to third embodiments described above, any two of them can be combined and applied, or all three of the first to third embodiments can be combined and applied.

Overlay Error Measurement

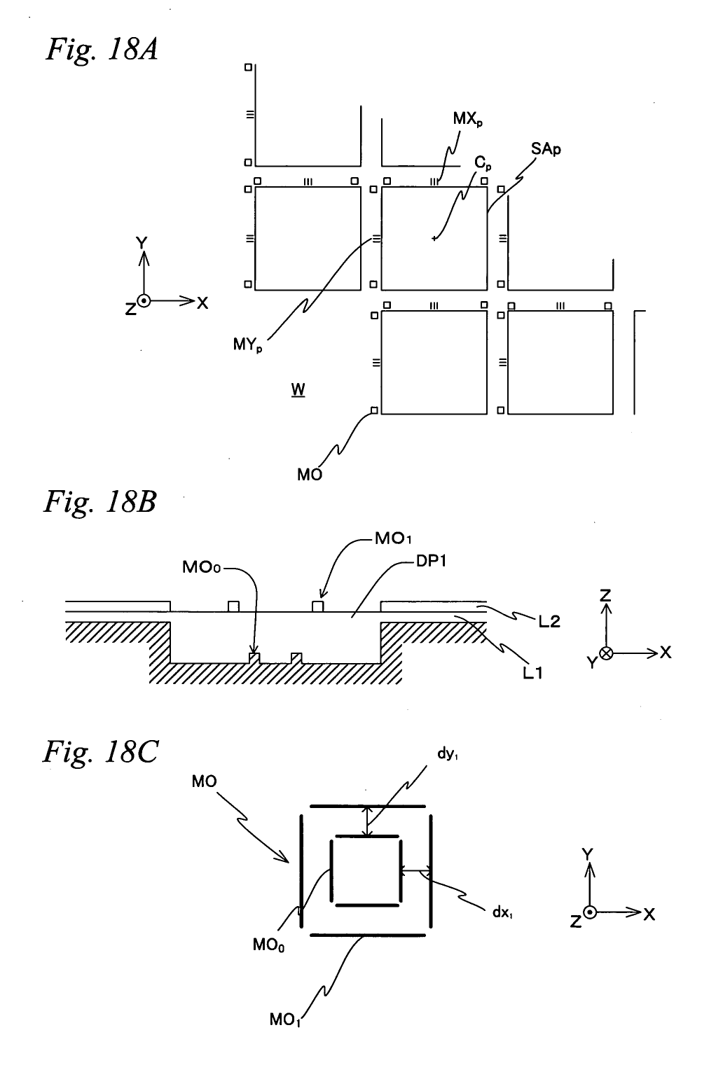

Further, in the first embodiment described above, while the case has been described where the alignment marks used to align the pattern were optimally designed, as well as the alignment marks, it is also possible to optimally design marks and the like which are used to measure an overlay error of two patterns formed on two different layers (a reference layer and a target layer) on the wafer, respectively. In FIG. 18A, as an example, a wafer W is shown which has four overlay error measurement marks MO₀ (shown by a reference code MO in FIG. 18A) transferred and formed in each shot area SAₚ along with a device pattern, when the reference layer is exposed. In FIG. 18A, reference codes MXₚ and MYₚ are X alignment marks and Y alignment marks, respectively.

In this case, in the exposure process of the reference layer, a reticle (referred to as a first reticle) on which a device pattern and overlay error measurement marks MO₀ having a known positional relation are formed is used. While a device pattern of the reference layer is formed on shot area Sₚ using this first reticle as shown in FIG. 18A, overlay error measurement marks MO₀ are formed on street SL at the same time. Then, by the treatment in the process until the exposure of the target layer, a step is to be formed between shot area Sₚ and street SL. In the exposure process of the target layer later on, a reticle (referred to as a second reticle) on which a device pattern and overlay error measurement marks MO₁ (refer to FIG. 18C) having a known positional relation are formed is used. In this case, overlay error measurement marks MO₁ on the second reticle are optimally designed, according to the procedure previously described in the first embodiment. Then, while a device pattern of the target layer is overlaid and formed on the device pattern on shot area Sₚ using the second reticle, overlay error measurement marks MO₁ are overlaid on overlay error measurement marks MO₀ on street SL at the same time. In this case, as overlay error measurement marks MO₀ and MO₁, as an example, a bar-in-bar mark as is shown in FIG. 18C is used.

As it can be seen from FIG. 18C, overlay error measurement mark MO₀ includes four line patterns which are a pair of line patterns whose longitudinal direction is in the X-axis direction and are placed apart in parallel by a predetermined distance in the Y-axis direction, and a pair of line patterns whose longitudinal direction is in the Y-axis direction and are placed apart in parallel by a predetermined distance in the X-axis direction, and has an overall shape of a rectangular mark (a box mark) which is almost a square that lacks the four corner portions.

Overlay error measurement mark MO₁ has an overall shape of a rectangular mark (a box mark) which is almost a square that lacks the four corner portions, and is a mark one size larger but almost similar to overlay error measurement mark MO₀.

These two overlay error measurement marks MO₀ and MO₁ are designed in a positional relation so that when exposure is performed without any overlay errors, the center of the reference layer and center of the target layer coincide with each other.

Accordingly, after the development (and the etching process) of the wafer on which overlay error measurement mark MO₁ is formed, positional shift (dx, dy) of overlay error measurement mark MO₀ overlaid and formed on street SL with overlay error measurement mark MO₀ is measured, using an overlay measurement device (also referred to as an alignment deviation inspection device) and the like. A similar overlay error measurement mark is arranged in shot area Sₚ in plurals, and an overlay error of the device pattern which is formed overlaid within shot area Sₚ is obtained for all of the marks from positional shift (dx, dy). At this point, because overlay error measurement mark MO₁ is optimally designed in the procedure previously described, position measurement error of overlay error measurement mark MO₁ caused at least by a step between shot area Sₚ and the street hardly occurs. Accordingly, in the case when the step between the shot area (device pattern area) of the reference layer and the street is almost zero, it becomes possible to measure the overlay error of the device pattern formed on the target layer with respect to the device pattern of the reference layer with good precision. Incidentally, if overlay error measurement mark MO₀ is optimally designed according to the procedure previously described, it becomes possible to perform an overlay error measurement with a much higher accuracy.

Further, in the second embodiment described above, while the case has been described where a dummy pattern is formed to flatten the wafer, and a new alignment mark is formed on the dummy pattern, as well as the alignment mark, for example, an overlay error measurement mark and the like can also be formed. As the overlay error measurement mark, overlay error measurement mark MO (MO₀, MO₁) previously described, consisting of a bar-in-bar mark can be used (refer to FIGS. 18A and 18C).

In this case, according to the procedure previously described, while the device pattern of the target layer is formed in function membrane L2 on shot area Sₚ as shown in FIG. 18B, overlay error measurement mark MO₁ (and the new alignment mark) is formed on dummy pattern DP of street SL at the same time, as in the case of FIG. 16D. In this case, overlay error measurement mark MO₁ is formed overlaying overlay error measurement mark MO₀ formed at the same time as the device pattern of the reference layer.

Now, as is previously described, when exposure is performed without any overlay errors, the two overlay error measurement marks MO₀ and MO₁ are designed in a positional relation so that the center of each of the overlay error measurement marks MO₀ and MO₁ coincide with the target layer.

Accordingly, after the development (and the etching process) of the wafer on which overlay error measurement mark MO₁ (and the new alignment mark) is formed on dummy pattern DP1 in street SL, positional shift (dx, dy) of overlay error measurement mark MO₀ overlaid and formed on street SL with overlay error measurement mark MO₀ is measured, using an overlay measurement device (also referred to as an alignment deviation inspection device) and the like. A similar overlay error measurement mark is arranged in shot area Sₚ in plurals, and an overlay error of the device pattern which is formed overlaid within shot area Sₚ is obtained for all of the marks from positional shift (dx, dy). This allows the overlay error to be measured of the device pattern to be formed on the target layer with respect to exposure on the device pattern of the reference layer. In this case as well, overlay error measurement mark MO₁ is formed on (dummy pattern DP1 of street SL on) wafer W without any deformation due to defocus. Accordingly, the overlay error measurement described above can be performed with good precision.

Further, in the third embodiment, while the case has been described where the detection results of the alignment marks (wafer marks) used to set the position of the pattern are corrected, as well as the alignment marks, detection results such as, for example, overlay error measurement marks and the like can also be corrected. As the overlay error measurement mark, overlay error measurement mark MO (MO₀, MO₁) previously described, consisting of a bar-in-bar mark can be used (refer to FIGS. 18A and 18C).

In this case, in the exposure process of the reference layer, the device pattern of the reference layer is formed on shot area Sₚ while forming overlay error measurement marks MO₀ on street SL at the same time using the first reticle previously described on which a device pattern and overlay error measurement marks MO₀ having a known positional relation are formed, as shown in FIG. 11A. Then, by the treatment in the process until the exposure of the target layer, a step is to be formed between shot area Sₚ and street SL. In the exposure process of the target layer later on, a device pattern of the target layer is overlaid and formed on the device pattern on shot area Sₚ while overlay error measurement marks MO₁ are overlaid on overlay error measurement marks MO₀ on street SL at the same time, using the second reticle previously described on which a device pattern and overlay measurement marks MO₁ having a known positional relation are formed.

Then, as is previously described, after the development (and the etching process) of the wafer on which overlay error measurement mark MO₁ is formed, positional shift (dx, dy) of overlay error measurement mark MO₀ overlaid and formed on street SL with overlay error measurement mark MO₀ is measured, using an overlay measurement device (also referred to as an alignment deviation inspection device) and the like. Furthermore, the positional relation (ΔX, ΔY) with respect to the device pattern of overlay error measurement mark MO₁ is corrected, using lateral shift ΔX_{AM} and ΔY_{AM} as is previously described. A similar overlay error measurement mark is arranged in shot area Sₚ in plurals, and an overlay error of the device pattern which is formed overlaid within shot area Sₚ is obtained for all of the marks from positional shift (dx, dy) and positional relation (ΔX, ΔY) which has been corrected. This allows the overlay error of the device pattern formed on the target layer with respect to the device pattern of the reference layer to be measured with good precision.

Incidentally, overlay error measurement mark MO (MO₀, MO₁) shown in FIGS. 18A to 18C is a mere example, and the size, the number per shot area, the placement position of the wafer mark and the overlay error measurement mark, the shape and the like can be changed appropriately. Accordingly, as the overlay error measurement mark, for example, a box-in-box mark can be used.

Further, in each of the embodiments described above, instead of, or along with reticle interferometer 14, an encoder (an encoder system made up of a plurality of encoders) can also be used. Similarly, instead of, or along with interferometer system 18, an encoder (an encoder system made up of a plurality of encoders) can also be used.

Incidentally, in each of the embodiments described above, while the alignment detection system of the image processing method was used, besides this, an alignment detection system that employs other detection methods, such as, for example, an alignment sensor, which irradiates a coherent detection light to a subject mark and detects a scattered light or a diffracted light generated from the subject mark or makes two diffracted lights (for example, diffracted lights of the same order or diffracted lights being diffracted in the same direction) generated from the subject mark interfere and detects an interference light, can naturally be used alone or in combination as needed.

Further, in each of the embodiments described above, while the case has been described where the embodiments were applied to a dry type exposure apparatus that performs exposure of wafer W without liquid (water), as well as this, as is disclosed in, for example, PCT International Publication No. 99/49504, EP Patent Application Publication No. 1,420,298, PCT International Publication No. 2004/055803, Kokai (Japanese Unexamined Patent Application Publication) No. 2004-289126 (corresponding U.S. Pat. No. 6,952,253) and the like, each of the embodiments described above can also be applied to an exposure apparatus which has a liquid immersion space formed including an optical path of the illumination light between a projection optical system and a wafer, and exposes the wafer with the illumination light via the projection optical system and the liquid in the liquid immersion space. Further, each of the embodiments described above can also be applied to the liquid immersion exposure apparatus and the like disclosed in, for example, PCT International Application No. 2007/097379 (the corresponding U.S. Patent Application Publication No. 2008/0088843). In the case of using such liquid immersion exposure apparatus in the first or third embodiment described above, the design conditions of alignment mark AM should be optimized, or the lateral shift or relative lateral shift can be obtained, taking into consideration the illumination conditions and the optical properties of projection optical system PL, as well as the refractive index of the liquid (or temperature or the distribution).

Further, in the first or third embodiment described above, while the case has been described where exposure apparatus 100 was a scanning exposure apparatus, other exposure apparatuses can be used as well. For example, exposure apparatus 100 can be a static exposure apparatus. Further, the exposure apparatus can also be a reduction projection exposure apparatus by a step-and-stitch method that synthesizes a shot area and a shot area, an exposure apparatus by a proximity method, a mirror projection aligner or the like. Moreover, the exposure apparatus also can be a multi-stage type exposure apparatus equipped with a plurality of wafer stages, as is disclosed in, for example, U.S. Pat. No. 6,590,634, U.S. Pat. No. 5,969,441, U.S. Pat. No. 6,208,407 and the like. In such an exposure apparatus, the baseline does not have to be obtained, and only the projection position of the reticle mark has to be measured in an exposure station (the position where the exposure of the wafer is performed via a projection optical system). Further, focus sensor AF should be provided not in the vicinity of the projection optical system but only at the measurement station (in the vicinity of the alignment detection system).

Further, the exposure apparatus can be an apparatus equipped with a measurement stage including a measurement member (for example, a fiducial mark, and/or a sensor and the like) separately from the wafer stage, as is disclosed in, for example, PCT International Publication No. 2005/074014 (the corresponding U.S. Patent Application Publication 2007/0127006) and the like.

Further, projection optical system PL in the first to third embodiments above is not only a reduction system, but also may be either an equal magnifying system or a magnifying system. Further, projection optical system PL is not only a dioptric system, but also may be either a catoptric system or a catadioptric system, and in addition, the projected image may be either an inverted image or an upright image. Further, the illumination area and exposure area were to have a rectangular shape; however, the shape is not limited to rectangular, and can also be circular arc, trapezoidal, parallelogram or the like.

Further, in the first to third embodiments described above, the light source of exposure apparatus 100 is not limited to the ArF excimer laser, and a pulse laser light source such as a KrF excimer laser (output wavelength 248 nm), an F₂ laser (output wavelength 157 nm), an Ar₂ laser (output wavelength 126 nm) or a Kr₂ laser (output wavelength 146 nm), or an extra-high pressure mercury lamp that generates an emission line such as a g-line (wavelength 436 nm), an i-line (wavelength 365 nm) and the like can also be used. Further, a harmonic wave generating unit of a YAG laser or the like can also be used. Besides the sources above, as is disclosed in, for example, U.S. Pat. No. 7,023,610, a harmonic wave, which is obtained by amplifying a single-wavelength laser beam in the infrared or visible range emitted by a DFB semiconductor laser or fiber laser, with a fiber amplifier doped with, for example, erbium (or both erbium and ytterbium), and by converting the wavelength into ultraviolet light using a nonlinear optical crystal, can also be used as vacuum ultraviolet light.

Further, in the first to third embodiments described above, as illumination light IL of exposure apparatus 100, the light is not limited to the light having a wavelength equal to or more than 100 nm, and the light having a wavelength less than 100 nm can also be used. For example, each of the embodiments described above can be applied to an EUV (Extreme Ultraviolet) exposure apparatus that uses an EUV light in a soft X-ray range (e.g. a wavelength range from 5 to 15 nm). In addition, each of the embodiments described above can also be applied to an exposure apparatus that uses charged particle beams such as an electron beam or an ion beam.

Moreover, as disclosed in, for example, U.S. Pat. No. 6,611,316, each of the embodiments above can also be applied to an exposure apparatus that synthesizes two reticle patterns on a wafer via a projection optical system and almost simultaneously performs double exposure of one shot area on the wafer by one scanning exposure.

Incidentally, the object on which a pattern is to be formed (an object subject to exposure to which an energy beam is irradiated) in the first to third embodiments described above is not limited to a wafer, but may be other objects such as a glass plate, a ceramic substrate, a film member, or a mask blank.

The application of the exposure apparatus is not limited to an exposure apparatus for fabricating semiconductor devices, but can be widely adapted to, for example, an exposure apparatus for fabricating liquid crystal devices, wherein a liquid crystal display device pattern is transferred to a rectangular glass plate, as well as to exposure apparatuses for fabricating organic electroluminescent displays, thin film magnetic heads, image capturing devices (e.g. CCDs), micromachines, and DNA chips. Further, each of the embodiment described above can be applied not only to an exposure apparatus for producing microdevices such as semiconductor devices, but can also be applied to an exposure apparatus that transfers a circuit pattern onto a glass plate or silicon wafer to produce a mask or reticle used in a light exposure apparatus, an EUV exposure apparatus, an X-ray exposure apparatus, an electron-beam exposure apparatus, and the like.

Electronic devices such as semiconductor devices are manufactured through the steps of; a step where the function/performance design of the device is performed, a step where a reticle based on the design step is manufactured, a step where a wafer is manufactured from silicon materials, a lithography step where the pattern of a mask (the reticle) is transferred onto the wafer by the exposure apparatus (pattern formation apparatus) and the exposure method in the embodiment previously described, a development step where the wafer that has been exposed is developed, an etching step where an exposed member of an area other than the area where the resist remains is removed by etching, a resist removing step where the resist that is no longer necessary when etching has been completed is removed, a device assembly step (including a dicing process, a bonding process, the package process), inspection steps and the like. In this case, in the lithography step, because the device pattern is formed on the wafer by executing the exposure method previously described using the exposure apparatus in each of the embodiments above, a highly integrated device can be produced with good productivity.

Incidentally, the disclosures of all publications, the PCT International Publications, the U.S. Patent Application Publications and the U.S. Patents that are cited in the description so far related to exposure apparatuses and the like are each incorporated herein by reference.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An exposure method in which a pattern is overlaid and formed in each of a plurality of first areas arranged on an object via a projection optical system, the method comprising:
performing a suppressing means of an exposure error occurring due to a positional shift of a second area in which a mark corresponding to the plurality of first areas and the first area corresponding to the mark within a plane orthogonal to an optical axis of the projection optical system when the pattern is formed in each of the plurality of first areas arranged on the object.

2. The exposure method according to claim 1 wherein
the suppressing means of the exposure error includes an optimal design of the mark to minimize the positional shift.

3. The exposure method according to claim 2 wherein
the optimal design of the mark includes obtaining a first positional shift of an image of the pattern projected on the object via the projection optical system and an image of the mark within the plane orthogonal to the optical axis of the projection optical system taking into consideration optical properties of the projection optical system, for each of a plurality of conditions at least including an illumination condition to illuminate a mask on which the pattern and the mark are formed, with respect to a second positional shift of the image of the pattern and the image of the mark in a direction parallel to the optical axis, and
optimizing a design condition of the mark, based on the second positional shift and the first positional shift corresponding to the second positional shift.

4. The exposure method according to claim 3 wherein
the design condition is optimized so that the degree of the change of the first position shift to the second position shift is minimized.

5. The exposure method according to claim 3 wherein
a surface on the object on which an image of the pattern is projected is assumed to be positioned at a focus of the projection optical system.

6. The exposure method according to claim 3 wherein
the design condition includes at least one of a type, shape, and position of the mark.

7. The exposure method according to claim 3 wherein
the illumination condition includes at least one of a light source to be used, illumination method, illuminance on the mask, and illuminance on the object.

8. The exposure method according to claim 3 wherein
the plurality of conditions further include a detection condition to detect a mark formed on the object.

9. The exposure method according to claim 8 wherein
the detection condition includes an irradiation condition of a detection light which irradiates the mark to detect the mark.

10. The exposure method according to claim 3 wherein
at least one of aberration and telecentricity is considered as optical properties of the projection optical system.

11. The exposure method according to claim 2, the method further comprising:
forming the mark in the second area, along with forming the pattern in each of the plurality of the first areas, by irradiating an energy beam on a photosensitive layer formed on the object, via a mask on which the mark having undergone the optimal design is formed together with the pattern, and the projection optical system.

12. The exposure method according to claim 11, the method further comprising:
of a plurality of the marks which are formed in the second area corresponding to the plurality of first areas on the object, detecting at least apart of the marks, and overlaying and forming a following pattern on the pattern formed in the plurality of first areas based on results of the detection.

13. The exposure method according to claim 12 wherein
on detecting the mark, a third positional shift is measured in a direction parallel to the optical axis of the projection optical system for the plurality of first areas on the object on which the pattern is formed and a part of an area of the second area on which the mark is formed, and detection results of the mark are corrected, using the third positional shift which has been measured and a predetermined correction information.

14. The exposure method according to claim 13 wherein
the correction information can be obtained, by obtaining a first positional shift in the plane orthogonal to the optical axis of the projection optical system for an image of the pattern projected on the plurality of first areas on the object via the projection optical system and an image of the mark projected on a part of the second area via the projection optical system, with respect to a second positional shift in a direction parallel to the optical axis for the image of the pattern and the image of the mark, taking at least optical properties of the projection optical system into consideration prior to overlaying and forming the pattern.

15. The exposure method according to claim 14 wherein
on correcting the detection results, the first positional shift corresponding to the second positional shift which is equal to a measurement result of the third positional shift is used.

16. The exposure method according to claim 1 wherein
the suppressing means of an exposure error includes performing a flattening processing to avoid a step from occurring between a target portion in at least a part of the second area on which the mark corresponding to each of the plurality of first areas and the first area.

17. The exposure method according to claim 16 wherein
the flattening processing includes performing an exposure which reduces the step of the target portion in at least apart of the second area with respect to the first area.

18. The exposure method according to claim 16 wherein
the flattening processing includes embedding the target portion with a predetermined material.

19. The exposure method according to claim 16, the method further comprising:
forming a mark on a portion where the step with respect to the first area has been reduced by the flattening processing, by performing an alignment with respect to a predetermined point of the object.

20. The exposure method according to claim 19, the method further comprising:
detecting a plurality of marks that at least include the mark after the mark has been formed, and overlaying and forming the pattern on each of the plurality of first areas, based on results of the detection.

21. The exposure method according to claim 1 wherein
the suppressing means of an exposure error includes obtaining a first positional shift within a plane orthogonal to the optical axis of the projection optical system for an image of the pattern projected on the plurality of first areas on the object via the projection optical system and an image of the mark corresponding to the first area projected on a part of the second area on the object via the projection optical system.

22. The exposure method according to claim 21 wherein
the first positional shift is obtained, taking into consideration at least optical properties of the projection optical system.

23. The exposure method according to claim 22 wherein
the first positional shift is obtained, with respect to a second positional shift in a direction parallel to the optical axis of the projection optical system for the image of the pattern and the image of the mark.

24. The exposure method according to claim 22 wherein
as the optical properties of the projection optical system, at least one of aberration and telecentricity is taken into consideration.

25. The exposure method according to claim 21 wherein
an illumination condition to illuminate a mask on which the pattern and the mark are formed is further considered

26. The exposure method according to claim 25 wherein
the illumination condition includes at least one of a light source to be used, illumination method, illuminance on the mask, illuminance on the object, and a type of photosensitive layer provided on the object.

27. The exposure method according to claim 25 wherein
the first positional shift is obtained, with a positional shift on the object corresponding to a positional shift of the pattern and the mark on the mask, serving as a reference.

28. The exposure method according to claim 21, the method further comprising:
detecting a position of a mark formed in the second area on the object; and
forming the pattern in the first area on the object, using the first positional shift which has been obtained and detection results of the position of the mark.

29. The exposure method according to claim 28 wherein
in the forming of the pattern, the detection results of the position of the mark with respect to a projection position of the pattern is corrected, using the first positional shift.

30. The exposure method according to claim 28 wherein
in the forming of the pattern, a target position of the object which is to be aligned with respect to a projection position of the pattern is corrected, using the first positional shift.

31. The exposure method according to claim 30 wherein
in the forming of the pattern, a third positional shift in a direction parallel to the optical axis is measured for the first area on which the pattern is formed and the second area on which the mark is formed, and forms the pattern on the object, further using results of the measurement.

32. The exposure method according to claim 31 wherein
in the forming of the pattern, the first positional shift corresponding to the second positional shift which is equal to a measurement result of the third positional shift is used.

33. The exposure method according to claim 28, the method further comprising:
prior to the detection,
a processing is performed which reduces a step of at least a part of the second area on which the mark corresponding to each of the plurality of first areas on the object is formed, with respect to the corresponding first area; and
the mark is formed on a portion where the step with respect to the corresponding first area has been reduced.

34. The exposure method according to claim 21 wherein
in the obtaining, a detection condition to detect the mark formed on the object is further taken into consideration.

35. The exposure method according to claim 21 wherein
in the obtaining, a design condition of the mark including at least a type, shape, and position of the mark is further taken into consideration.

36. The exposure method according to claim 21 wherein
in the obtaining, the first area on which an image of the pattern is projected is assumed to be positioned within a depth of focus of the projection optical system.

37. A device manufacturing method, including
forming a pattern on an object by the exposure method according to claim 1; and
developing the object on which the pattern is formed.

38. An exposure method in which a pattern is overlaid and formed in each of a plurality of first areas arranged on an object, the method comprising:
performing exposure to the object to reduce a step of a target portion, which is at least a part of a second area on which a plurality of first marks are formed corresponding to the plurality of first areas, with respect to the first area, by detecting the plurality of first marks and performing alignment of the object to a predetermined point based on results of the detection; and
forming a second mark on the target portion and overlaying and forming the pattern in each of the plurality of first areas, by detecting the plurality of first marks, performing alignment of the object to a predetermined point based on results of the detection, and exposing the object.

39. The exposure method according to claim 38 wherein
in the performing exposure, an exposure in which a part of the target portion serves as an exposure section, and a part of the other sections serves as an unexposed section is performed.

40. The exposure method according to claim 38 wherein
in the performing exposure, an exposure to form a dummy pattern on the target portion is performed to the object.

41. The exposure method according to claim 39 wherein
in the performing exposure, exposure to form the dummy pattern, as well as overlay and form a pattern in each of the plurality of first areas is performed to the object.

42. The exposure method according to claim 38 wherein
a processing of the performing exposure is repeated a plurality of times to flatten an upper surface of the object.

43. The exposure method according to claim 38, the method further comprising:
overlaying and forming the pattern further in each of the plurality of first areas, by detecting a plurality of marks that at least include the second mark after the overlaying and forming of the pattern, and using results of the detection.

44. The exposure method according to claim 38 wherein
at least a part of the plurality of first marks are inside the second area, and in the performing exposure, the target portion is the part inside the second area including the at least a part of the first marks.

45. The exposure method according to claim 44 wherein
in the overlaying and forming the pattern, the second mark is overlaid on the at least a part of the first marks.

46. The exposure method according to claim 45 wherein
in the overlaying and forming the pattern, detection conditions to detect the at least a part of the first marks is decided according to a characteristic of a member covering the first mark within the second area.

47. The exposure method according to claim 45 wherein
the at least a part of the first marks and the second mark formed overlaying the first mark are overlay error measurement marks.

48. The exposure method according to claim 38 wherein
performing the exposure and overlaying and forming a pattern are executed, each time a depth of the second area exceeds a threshold depth.

49. The exposure method according to claim 38 wherein
performing the exposure and overlaying and forming a pattern are executed, each time a predetermined pattern of a plurality of layers are overlaid and formed.

50. The exposure method according to claim 38 wherein
in the performing exposure, unevenness of the object upper surface is measured and the second area is specified.

51. The exposure method according to claim 38 wherein
the pattern is formed on the object by projecting an image of the pattern on the object via a mask on which the pattern and a mark are formed and a projection optical system, and
the mark is designed, based on results which can be obtained when obtaining a positional shift within a plane orthogonal to an optical axis of the projection optical system of the image of the pattern projected on the object via the projection optical system and the image of the mark, with respect to a positional shift in a direction parallel to the optical axis of the image of the pattern and the image of the mark, taking into consideration optical properties of the projection optical system.

52. The exposure method according to claim 38 wherein
forming the pattern, the first mark, and the second mark on the object is performed by irradiating an energy beam on a photosensitive layer formed on the object.

53. A device manufacturing method, including
forming a pattern on an object by the exposure method according to claim 38; and
developing the object on which the pattern is formed.

54. A device manufacturing method including overlaying and forming a pattern in each of a plurality of first areas arranged on an object, the method comprising:
performing a flattening processing to flatten a target portion, which is at least a part of a second area on which a plurality of first marks are formed corresponding to the plurality of first areas, by detecting the plurality of first marks and performing alignment of the object to a predetermined point based on results of the detection; and
detecting the plurality of first marks, performing alignment of the object to a predetermined point based on results of the detection, and forming a second mark on the target portion which has been flattened with respect to the first area.

55. The device manufacturing method according to claim 54 wherein
in performing the flattening processing, the target portion is embedded with a predetermined material.

56. The device manufacturing method according to claim 54 wherein
in performing the flattening processing, a dummy pattern is formed on the target portion.

57. An overlay error measurement method in which an overlay error for two patterns formed via a projection optical system on each of a reference layer and a target layer on an object is measured, the method comprising:
optimizing a design condition of a mark by obtaining a first positional shift of an image of the pattern projected on the object via the projection optical system and an image of the mark within the plane orthogonal to the optical axis of the projection optical system, with respect to a second positional shift of the image of the pattern and the image of the mark in a direction parallel to the optical axis, and optimizing a design condition of the mark, based on the second positional shift and the corresponding first positional shift, for each of a plurality of conditions including an illumination condition to illuminate a mask on which the pattern and the mark are formed taking into consideration optical properties of the projection optical system;
performing an exposure using a first mask on which a first pattern and a first mark whose positional relation is known is formed, so as to form the first pattern in a plurality of first areas on a reference layer of the object via the projection optical system, and at the same time, form the first mark in a second area corresponding to the plurality of first areas;
performing an exposure using a second mask on which a first pattern and a second mark whose design condition is optimized by the optimizing and positional relation is known is formed, so as to form the second pattern on a target layer overlaying the first pattern on the object, and at the same time, form the second mark overlaying the first mark in the second area; and
computing an overlay error of the first pattern and the second pattern, by measuring a positional shift of the first mark formed on the second area on the object and the second mark.

58. The overlay error measurement method according to claim 57 wherein
the design condition is optimized so that the degree of the change of the first position shift to the second position shift is minimized.

59. The overlay error measurement method according to claim 57, the method further comprising:
optimizing a design condition of the first mark of the first mask by the optimizing.

60. An overlay error measurement method in which an overlay error for two patterns formed via a projection optical system on each of a reference layer and a target layer on an object is measured, the method comprising:
obtaining a first positional shift within a plane orthogonal to the optical axis of the projection optical system for an image of the pattern projected on a first area on the object via the projection optical system and an image of the mark projected on a second area on the object via the projection optical system, at least taking into consideration optical properties of the projection optical system;
performing an exposure using a mask on which a first pattern and a first measurement mark whose positional relation is known is formed, so as to form the first pattern in the first area on a reference layer of the object via the projection optical system, and at the same time, form the first measurement mark in the second area;
performing an exposure using a mask on which a second pattern and a second measurement mark is formed, so as to form the second pattern on a target layer overlaying the first pattern on the object, and at the same time, form the second mark overlaying the first mark in the second area; and
computing an overlay error of the first pattern and the second pattern, by measuring a positional shift of the first measurement mark formed on the second area on the object and the second measurement mark.

61. The overlay error measurement method according to claim 60 wherein
in the computing, the measurement results are corrected using the first positional shift.

62. The overlay error measurement method according to claim 60 wherein
in the obtaining, the first positional shift is obtained, with respect to a second positional shift in a direction parallel to the optical axis of the projection optical system for the image of the pattern and the image of the mark.

63. The overlay error measurement method according to claim 62 wherein
in the computing, a third positional shift in a direction parallel to the optical axis is measured for the first area on which the second pattern is formed and the second area on which the second mark is formed, and the overlay measurement error is computed, further using the measurement results.
